(19) United States
(12) Patent Application Publication
(10) Pub. No.: US 2005/0137962 A1
(43) Pub. Date: Jun. 23, 2005

(54) Quick-filling customer asset trading system

(76) Inventors: Neill Penney, Surrey (GB); Philip Weisberg, New York, NY (US)

Correspondence Address: LAW OFFICES OF GRADY L. WHITE, LLC, 7272 WISCONSIN AVE, SUITE 300, BETHESDA, MD, 20814, US

(21) Appl. No.: 10/996,613

(22) Filed: Nov. 26, 2004

Related U.S. Application Data
(60) Provisional application No. 60/524,841, filed on Nov. 26, 2003.
(60) Provisional application No. 60/547,770, filed on Feb. 27, 2004.
(60) Provisional application No. 60/581,762, filed on Jun. 23, 2004.

(51) Int. Cl. G06F 17/60

(52) U.S. Cl. 705/37

(57) ABSTRACT

Apparatus and methods for use by a customer for trading assets, such as foreign exchange instruments, using a variety of trading protocols on an interconnected computer network, such as the Internet. The invention generates and displays easy-to-use, context-sensitive and meaningfully organized panels or windows containing visibly distinctive, user-activatible selectors and input controls the customer can manipulate to select and execute trades against the best available quotes as they are supplied by multiple providers. In a single-bank execution mode, the invention automatically determines the best quotes received from a multiplicity of providers and helps the customer submit a single-bank order to one of those providers. In a multi-bank execution mode, the invention automatically identifies and helps customers submit a best multi-bank order, which may comprise a combination single-bank orders split up among multiple providers who have each submitted quotes having insufficient sizes. The user also may specify other trading terms, such as trading accounts and order sizes, for the assets to be traded.

### CROSS-REFERENCE TO RELATED APPLICATIONS

This application is related and claims priority under 35 U.S.C. §119 to provisional application No. 60/524,841, filed on Nov. 26, 2003, provisional application No. 60/547,770, filed Feb. 27, 2004, and provisional application No. 60/581,762, filed Jun. 23, 2004, which are all incorporated into this application in their entirety by this reference.

### FIELD OF ART

The present invention relates generally to computerized asset trading systems and more particularly to customer-operated computerized asset trading systems with interactive graphical user interfaces for submitting offers and/or orders against quotes received from one or more asset providers.

### RELATED ART

In today's global economy, investors, borrowers, lenders, buyers and sellers exchange (or “trade”) millions of dollars worth of assets, including, for example, cash, securities, merchandise, commodities and precious metals, on a daily basis. In the foreign exchange (“FX”) market, for example, participants agree to trade cash in one type of currency for cash in another type of currency for a specified price on a specified date. These agreements, which are collectively referred to as FX market instruments, include, for example, spot, forward (or forward outright) and swap contracts (defined below). In the money markets, participants make agreements to borrow and lend cash at a specified rate for a specified period of time. These agreements, which are collectively referred to as money market instruments, include certificates of deposit (CDs), repurchase agreements, treasury bills (T-bills), commercial paper, forward rate contracts, interest rate futures and interest rate options.

The borrowers, lenders, buyers and sellers trade these assets through asset dealers, who are sometimes referred to as “liquidity providers,” or “market makers.” In a typical scenario, a customer wishing to buy, sell, lend or borrow some quantity of assets will propose a transaction by sending a request for price quotes (sometimes through an intermediary party, such as a broker) to one or more of the liquidity providers. The liquidity providers respond by submitting quotes to the customers indicating at what prices the providers are willing to buy (or borrow) the assets, as well as what prices they are willing to sell (or lend) the assets. The buying or borrowing price is known as the “bid,” and the selling or lending price is known as the “offer.” The difference between the bid price and offer price is known as the “bid-offer spread,” and it is this spread which generates profits for the liquidity providers, since they are always buying and borrowing slightly more cheaply than they are selling and lending.

Automated asset trading systems have been introduced to facilitate faster, more efficient and, for auditing purposes, more traceable, trading transactions between customers and providers. Typically, these systems comprise a trading program (or, in some instances, a suite of trading programs) running on a customer's computer system (or network), which receives input from the user and sends electronic trading instructions in real-time to one or more trading programs running on the providers' computer systems (or networks). The customer's computer system and the providers' computer systems talk to each other by exchanging a series of messages on one or more data communication channels established within an interconnected computer network, such as the Internet, a dedicated wide area network (WAN), or a corporate intranet.

The messages carrying the providers' quotes and customers trading instructions may be channeled through an intermediate or centralized asset trading server (or “portal”) connected to the interconnected computer network. Typically, the intermediate server is configured to coordinate, compare, match, error-check and/or log the messages on behalf of the customers and liquidity providers. In some cases, the trading server is managed and operated by a third party. FX Alliance, LLC of New York, N.Y. (FXall) is one example of a third party operator of an online trading server for the FX market.

Existing computerized asset trading systems often include one or more graphical or text-based user interfaces configured to display to customers a significant amount of data associated with provider quotes (such as bid and offer prices, asset quantities, proposed settlement dates, trading accounts, etc.) and to receive from the customer specific trading instructions and selections responsive to the displayed data. The instructions and selections are typically generated through the use and manipulation of personal computer input devices well-known in the computer arts, such as, for example, keyboards, computer mice, trackballs, graphic tablets and stylus pens.

It has been found, however, that existing customer asset trading systems have shortcomings in the amount of data that must be entered and/or the number of steps that must be performed in order to identify the best quotes and submit the best orders in the timeliest fashion. These shortcomings tend to prevent existing customer asset trading systems from meeting some of the most important asset trading goals of customers. In the FX markets, for example, prices and quantities associated with quotes for proposed trades often change significantly from one moment to the next, and some quotes may be withdrawn or go stale after only a few seconds. So users often need to evaluate a significant number of quotes on display, and generate and submit error-free trading instructions very quickly before the market changes and a window of opportunity has been lost. Performing these tasks quickly and without making any significant analytical or data keying errors can be very difficult, particularly in cases where a large number of quotes for a large number of proposed trades are displayed to the customer simultaneously. In this environment, the existing customer asset trading systems require too much time to identify the best quotes, as well as too much user input and too many steps to submit, confirm and execute the best orders based on those quotes. Typically, by the time the customer has submitted the proper trading instructions, the market has moved or the most desirable quotes have expired of been withdrawn. These problems and disadvantages significantly undermine the customers' ability to achieve their asset trading goals.

### SUMMARY OF THE INVENTION

The present invention addresses the above-described shortcomings associated with conventional customer asset trading systems by providing systems and methods customers can use to easily and quickly identify, select and submit orders against the best quotes in a plurality of quotes received from a plurality of providers. The invention may be applied in a variety of different trading contexts and to a variety of different asset classes and trading markets, including, but not limited to, foreign exchange, money markets, securities, cash deposits, commodities and precious metals. In the context of FX trading, a proposed trade may comprise, for example, a proposal to exchange a certain quantity of one currency for another. Typically, such proposals are expressed by initiating or requesting delivery of price quotes for the transaction.

In general, the invention comprises a computer system configured to receive from a provider (or a multiplicity of providers) a plurality of quotes associated with a proposed trade and to automatically determine which quotes are dealable, which are insufficient, and which may be pooled together to form a multi-bank order to create the best overall price. The system then displays to the customer the quotes received from a selected set of providers. Further, the system displays the best dealable quotes, best insufficient quotes and best multi-bank orders in a manner that visibly distinguishes them from other quotes. Using the visible distinctions provided by the invention, the customer can quickly and easily identify the best quotes and create and submit orders against those quotes, usually with only one or two clicks of his or her mouse button.

One embodiment of the computer system comprises a network interface, a quote processor, a user interface and an order processor. The network interface is configured to receive a plurality of quotes associated with a proposed trade, each quote in the plurality of quotes having a quoted price and a quoted size. The quotes may comprise two-way quotes or, alternatively, one-way quotes in each direction with different order sizes. The quote processor, which is coupled to the network interface, identifies a set of dealable quotes in the plurality of quotes by comparing the quoted size with a desired order size specified by the customer through various input means typically available on personal computer workstations and as described below. A quote is considered dealable if it has a quoted size that is not less than the customer-specified order size for the proposed trade. The user interface (a) displays the quotes to the customer in a manner that visibly distinguishes dealable and best dealable quotes, and (b) accepts quote selections and other trading instructions from the customer. The order processor submits orders based on the selections and trading instructions received from the customer via the user interface.

In another aspect of the invention, there is provided a computer-implemented method for executing trades. The method comprises the steps of (1) receiving a plurality of quotes associated with the proposed trade, each quote in the plurality of quotes comprising a quoted price and a quoted size; (2) providing a user interface comprising a display device, an input device and an input field; (3) receiving, via the input field and the input device, a customer order size from a customer; (4) identifying the set of dealable quotes in the plurality of quotes; (5) displaying on the display device a trading panel comprising a plurality of price selectors and size selectors, each price selector representing a quoted price in the plurality of quotes, each size selector representing a quoted size in said plurality of quotes, and each dealable quote in the trading panel being visibly distinguished from price selectors for non-dealable quotes; and (6) responsive to activation of the input device to select any price selector shown in the trading panel, booking an order using the customer order size and an order price equal to the quoted price represented by the selected price selector.

In preferred embodiments, the invention may be configured to operate in one of two different execution modes. In the single-bank execution mode, the invention operates under a one-order-to-one-fill trading scenario, where the customer can only accept one provider's price at a time. In other words, each order accepted by the customer is sent to one, and only one, provider. In the multi-bank execution (MBE) mode, the invention automatically splits the customer's order across multiple providers, as necessary, to meet the customers' needs, thereby creating a “multi-bank quote” comprising two or more single-bank quotes. MBE mode allows customers to execute deals up to their maximum order size when one or more providers are quoting smaller sizes than the customer desires. An execution is split into tranches on the basis of the best available prices until the customer's full order size is satisfied.

For instance, if the customer's specified order size is 50 million units, and no single provider can supply that many units, the system may generate and show to the customer a multi-bank quote comprising a combination of several smaller, single-bank quotes, each received from a different provider. If the customer selects the multi-bank quote, the several single-bank quotes are executed together in a “multi-bank order.” So that the customer obtains the best possible overall price for the multi-bank order, the invention automatically determines the best combination of single-bank orders to use for generating the best multi-bank order. Liquidity at the best price is used first, then liquidity at the next best price, and so on, until the entire customer order size is allocated.

Multiple execution modes support efficient dealing for large and small sizes. Preferably, the user interface of the invention is configured to display an input control, which the customer can use (or toggle) to switch between the two execution modes, depending on the customer's specific trading and order-filling requirements.

Accordingly, the quote processor is configured, in some embodiments, to successively select a plurality of best insufficient quotes, each one of which may be received from a different provider, to create a best multi-bank order. Typically, but not necessarily, the quotes selected to create a multi-bank order will constitute a combination of insufficient quotes. In these embodiments, the display screen generator will also display a best multi-bank order selector (e.g., a button, menu item or icon), which, if selected by the user, will cause the order processor to book at least two orders comprising a first order based on the first best insufficient quote selected and at least one other order based on at least one other best insufficient quote. The system will book as many orders as necessary to complete the multi-bank order. Notably, even if a customer is using the invention in MBE mode, a multi-bank order may be displayed and booked from a single provider if that provider quotes a sufficient order size to meet the customer's needs.

The trading panel may also be configured to display bid and ask limit input controls, configured to receive customer-specified limits on the kind of quotes the system may use to form a best multi-bank order. Based on these limits, the system may be configured to exclude from consideration any quotes which are numerically less than the bid limit specified or numerically higher than the ask level specified. Thus, by using these controls, the customer may prevent the system from using any quotes having prices that are “worse than” the customer's specified bid and ask limits.

As described above, one feature of the invention is the trading panel, which provides visibly distinctive selectors (e.g., highlighted, specially-colored, blinking and/or flashing buttons, text or symbols) for the best quotes for each proposed trade. The customer can quickly fill orders by activating selectors representing the best quotes received from any one of the multiple providers (in single bank execution mode) or, alternatively, from a plurality of providers (in multi-bank execution mode). The invention performs the calculations necessary to identify the best quotes prior to displaying the quotes in the trading panel. Another feature of the invention is that it provides a second panel (referred to herein as a quotes panel), which displays a group of best quotes received from multiple providers for a group of proposed trades.

An optional feature of the invention is that it can operate in conjunction with both single- and multi-provider trading systems, whereby the single-provider system allows the customer to quickly and efficiently submit an order to a single provider (either specifically chosen by the customer, or to the provider with the best price), while the MBE mode allows the customer to quickly and efficiently create and submit an order to multiple providers. Preferably, the trading panel and the quotes panel are synchronized so that the user can select which proposed trade panel to view by selecting or activating a control in the quotes panel.

Together, these features provide significant advantages over existing customer asset trading systems in terms of time, effort and costs associated with submitting orders and executing trades in a variety of different asset trading contexts. As stated above, customers can identify the best quotes immediately, based on the visual distinctions applied to price and size selectors associated with the best quotes. Another advantage is that Customers may quickly fill orders based on the best quotes merely by selecting the visibly-distinctive price selectors, and therefore, are not required to perform the time-consuming and error-prone tasks of manually keying in pricing and size information for the best deals. Yet another advantage is that the system provides a way for customers to withhold information about there trading needs because the order sizes are not given until a customer submits an order. In this respect, a customer can, more or less, watch the market anonymously until he or she is ready to submit an order.

### BRIEF DESCRIPTION OF THE DRAWINGS

The present invention and various aspects, features and advantages thereof are explained in detail below with reference to exemplary and therefore non-limiting embodiments and with the aid of the drawings, which constitute a part of this specification and include exemplary embodiments of some of the various forms of the invention. In these drawings:

FIG. 1 shows a high-level block diagram of a customer asset trading system configured to operate according to an embodiment of the present invention.

FIG. 2 shows a high-level block diagram of a computer network configured to operate according to an embodiment of the invention.

FIG. 3 contains a flow diagram illustrating, at a high level, the major steps typically performed by embodiments of the present invention, such as the customer trading system shown in FIG. 1, to implement a quick-filling customer asset trading system.

FIG. 4 shows an algorithm that may be used to identify the best dealable and best insufficient quotes.

FIGS. 5 and 6 show an algorithm that may be used in embodiments of the invention to identify the best multi-bank order based on a plurality of quotes received from a plurality of banks.

FIG. 7 shows an exemplary screen shot of a trading panel as it may be displayed on the display device, according to one embodiment of the invention, when the invention is operated in the single-bank execution mode.

FIG. 8 shows an exemplary screen shot of a trading panel as it may be displayed on the display device when the invention is operated in the multi-bank execution mode.

FIG. 9 shows an exemplary screen shot of a quote panel that may be drawn on the user's display device in an embodiment of the invention.

FIG. 10 shows an exemplary screen shot of a display screen configured to display, according to an embodiment of the invention, both a quote panel and a trading panel simultaneously.

FIG. 11 shows a close up view of the portions of a desktop display generated by the present invention which contain the selectors a customer may use to submit orders.

### DETAILED DESCRIPTION OF PREFERRED EMBODIMENTS

The detailed description of preferred embodiments provided herein refers primarily to foreign exchange (FX) trades and assets comprising foreign exchange (FX) instruments. However, these references are only meant to illustrate, by way of example, how the invention may be made and practiced in the context of the foreign exchange instrument asset class; not to serve as a limitation on the applicability of the invention to other asset classes. Upon reading the detailed description that follows, it will be apparent to those skilled in the art that asset trading systems configured to operate according to the principles of the present invention would provide substantial benefits and advantages when trading assets of other classes, such as money market instruments, cash deposits, precious metals, commodities and securities. Therefore, asset trading systems used to trade assets that are not related to foreign exchange transactions are not outside the scope of the claimed invention.

Definition of Terms

As used in this description, except to the extent that the context indicates otherwise, the following terms may be understood with reference to the definitions provided below.

FX Terms

A “foreign exchange” or “FX” transaction (or “deal”) is a contract to exchange one currency for another at an agreed rate on a specified delivery date, also called a “value date” or “settlement date.”

A “value date” or “settlement date” is the date on which the actual exchange of currencies will take place.

The terms “FX spot deal,” “spot trade,” “spot agreement” and “spot contract” refer to a transaction or agreement to exchange a single foreign currency for another (i.e., to buy X units of one currency, sell Y units of another currency) on the FX spot date, which is defined below.

A “spot rate” is a rate (expressed as combination of a bid (buy) price and an offer (sell) price) at which a market maker will buy and sell the base currency against another currency.

The “spot date” is usually two working days after the date the agreement is made. For most FX transactions, the most liquid (i.e. cheapest) settlement date to buy or sell currency is the FX spot date.

The terms “forward,” “forward outright” and “forward contract” refer to any transaction that settles on a date beyond the spot date (defined above).

The terms “swap,” “swap agreement” and “swap contract” refer to deals involving the simultaneous purchase and sale, or sale and purchase, of a specified amount of one currency against another for two different value dates. Although a swap is a single transaction with a single counterparty, the transaction has two value dates (or “legs”) when the exchanges of funds occur.

Parties

The term “Provider” is typically a shorthand reference to a “Liquidity Provider.” A “Liquidity Provider” is typically a financial institution, such as a bank, that serves as a market maker in a trading system. Liquidity Providers quote prices in response to requests from “Customers.”

The term “bank,” as used herein, is typically interchangeable with the term “Provider.”

The terms “dealer,” “trader” and “treasurer” typically refer to employees of the bank or Liquidity Provider who monitor the Liquidity Provider's online asset trading system and respond to requests for price quotes and offers to make deals as they are received from Customers.

The term “Customer” typically refers to the party in a trading transaction who wishes to buy or sell assets and who is not a Provider or employee of a Provider. Customers initiate the dealing process by asking one or more Providers for a price on a particular FX instrument, such as a swap, forward or spot agreement. The term “Customer” may also refer to an aggregation of users, as, for example, in a company.

The term “user,” unless a contrary meaning is stated, typically refers to a human operator, such as an employee at a Customer or Provider site, who operates or interfaces with a computer program or computer system programmed to request, invoke, execute and/or monitor online asset trading transactions. For instance, when the term “user interface” appears in connection with computer programs and computer systems operated by a Customer, it should be apparent from this context that the “user” is a human operator at the Customer's site.

The terms “dealt currency” and “base currency” refer to the fixed currency in a foreign exchange proposal or quote. For example, if a foreign exchange market participant proposes or quotes a deal to exchange 1 million euros for the equivalent amount of U.S. dollars, then the deal entails trading a fixed amount of euros against a variable amount of U.S. dollars. The amount of U.S. dollars depends on the exchange rate. Thus, the dealt currency in this transaction is euros. The U.S. dollar, on the other hand, is referred to as the “terms currency.”

Acronyms and Abbreviations

API=Application Programming Interface. Used colloquially without expansion to denote a specific method by which one computer program may make requests for data or services provided by another computer program.

OMS=Order Management System. An Order Management System is used by a Customer to maintain a record of FX deals that need to be executed in the market, who should execute them, etc. Once a deal is executed, the OMS is typically updated with the execution rate for each deal.

RFQ=Request For Quote. A trading protocol whereby the Customer initiates a trade by asking one or more Providers (sometimes through an intermediary, such as the operator of an online electronic trading platform or server) for a price quote on a particular asset. The Provider typically responds by sending a price back to the Customer (or the intermediary). In order to take the price, the Customer typically sends the Provider a message indicating a desire to deal on the quote, which is typically referred to as an “offer” or an “offer to deal.” Upon receipt of the offer or offer to deal, the Provider typically sends back a “confirmation” message, which may an acceptance or rejection of the offer to deal.

mio=million.

USD=United States Dollars.

GBP=United Kingdom Pound Sterling.

JPY=Japanese Yen.

CHF=Swiss Franc.

EUR=European Euro.

CAD=Canadian Dollars.

NOK=Norwegian Kroner.

Overview

The present invention provides an apparatus and method for trading assets in a variety of different trading contexts and under a variety of trading protocols using an interconnected network of computer systems. The invention generates and displays easy to use, highly effective and meaningfully organized panels (or “windows”) containing user-activatible and visibly distinctive input controls the user can manipulate to select prices and Providers for proposed trades, as well as to specify other trading terms, such as order sizes for the assets to be traded. Accordingly, preferred embodiments of the invention provides a way of quickly filling orders against quotes through a trading panel, which shows the Customer the best dealable quotes available for a proposed trade, the best insufficient quotes if none of the quotes are dealable, and the best multi-bank order if the assets from multiple providers are needed to fill the Customer's needs. The invention may also be configured to show to the Customer a “quotes panel,” which shows the Customer a plurality of best available prices for a plurality of proposed trades across multiple currency pairs, and orders may be submitted by clicking on buttons here without entering the trading panel.

In a basic configuration, the invention comprises a computer system having a network interface, a quote processor, a user interface and an order processor. The network interface receives a plurality of quotes associated with a proposed trade, each quote in the plurality of quotes having a quoted price and a quoted size. An example of a proposed trade is a proposed transaction to trade on a particular currency pair, a particular tenor or a particular maximum order size. The quote processor compares the quoted price in each quote with a desired order size specified by the customer in order to identify a set of dealable quotes in the plurality of quotes. Quotes having quoted sizes that are equal to or greater than the, customer-specified order size are considered dealable. But if a quote has a quoted size that is less than the customer-specified order size for the proposed trade, then the quote is not dealable. The user interface (a) displays the quotes to the customer in a manner that visibly distinguishes dealable and best dealable quotes, and (b) accepts quote selections and other trading instructions from the customer. The order processor submits orders based on the selections and trading instructions received via the user interface.

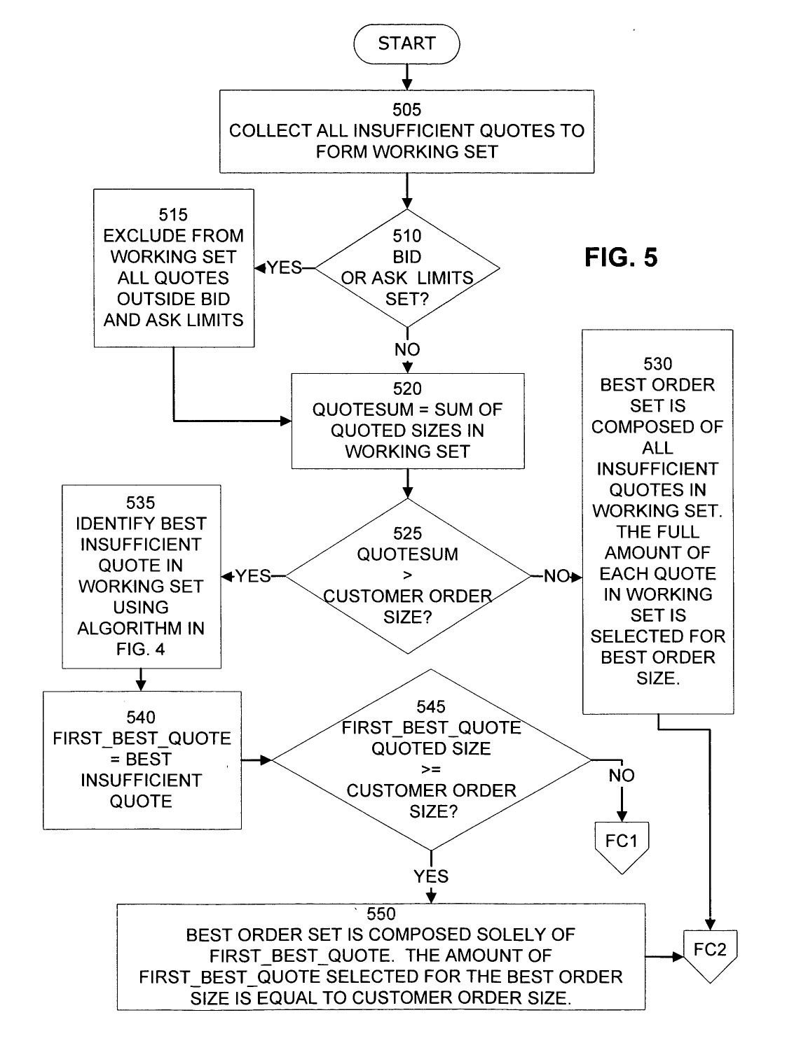

The user interface comprises a display screen generator, a display device and an input device. The display screen generator displays on the display device an input field configured to receive the customer-specified order size from the customer responsive to manipulation of the input device. The display screen generator also displays on the display device a trading panel (an example of such trading panel shown in FIG. 5 and discussed in detail below) comprising a detailed view of quotes received for the proposed trade, including, for example, the current quote from each Provider and the maximum order size supported by that Provider. Customers can use this trading panel to change the order size, select different Providers, and/or change a number of other trading parameters before the order is submitted for processing.

The trading panel also contains or shows a plurality of price selectors and size selectors, each price selector representing a quoted price in the plurality of quotes received from the Providers, and each size selector representing a quoted size in the plurality of quotes received from the Providers. The price and size selectors may take the form of text, buttons, icons, links or any other type of graphic image or symbol suitable for representing a control for selecting an option or initiating a programmed action in a computer program or application. The price selectors for dealable quotes are visibly distinguished from price selectors representing quotes that are not dealable. Such visible distinction may be achieved, for example, by using specially-colored backgrounds, or highlighted or flashing characters, for instance, on all price selectors representing the dealable quotes. Furthermore, price selectors for the “best” dealable quotes are further distinguished from every other price selector shown in the trading panel, including the price selectors for other dealable quotes. Thus, the Customer may easily distinguish and identify by visual inspection all of the price selectors representing the best dealable quotes, as well as all of the price selectors representing those quotes that are merely dealable (but not the best dealable).

In some cases, none of the quotes received from the Providers may be dealable. This can occur, for example, if all of the quoted sizes in the received quotes are insufficient when compared to the customer-specified order size. For instance, if the customer specifies an order size of 20 million dollars, and receives five different quotes offering to trade 1 million, 5 million, 10 million, 15 million and 17 million dollars worth of assets, respectively, then all five of the received quotes are insufficient and, therefore, would be deemed not dealable. Under these circumstances, the invention may be configured to visibly distinguish size selectors representing the best insufficient quote. A best insufficient quote is an insufficient quote having the greatest (or highest) quoted size, i.e., the quote with a quoted size closest to the customer-specified order size. In the previous example, the size selector representing the quoted size of 17 million dollars would be visibly distinguished from the size selectors representing the quoted sizes of 1, 5, 10 and 15 million dollars because the $17 million quote is the best insufficient quote.

The Customer may select the visibly distinguished price selector for the best dealable quote, thereby telling the system to book an order using the price represented by the selected price selector and an order size equal to the Customer's order size. Alternatively, the Customer may select a visibly distinctive size selector for the best insufficient quote, thereby telling the system to book an order using the quoted size represented by the selected size selector, despite the fact that the quoted size is less than the size originally requested by the Customer.

The display device is typically a personal computer monitor or laptop computer display screen, as well as the associated hardware connections and/or software required to generate and display images and text thereon. However, the display device may also comprise the display screen and associated hardware connections and software used to drive a television monitor, portable cellular telephone or personal digital assistant (PDA). The display device may also be implemented via the use of one or more “windows” associated with the Microsoft Windows® Operating System provided by Microsoft Corporation of Redmond, Wash.

The input device typically comprises a keyboard and some kind of pointing and selection device, such as a mouse, stylus pen, track ball or tracking wheel. The input device may also be implemented using more advanced human interface technology known in the computer arts, such as with microphones, speakers and voice recognition technology. In some embodiments, multiple display devices and/or multiple input devices may be used simultaneously, and may also be combined in ways well-known in the computer arts in order to achieve faster or more user-friendly operation by a human. A touch-screen-enabled display monitor, for example, which combines the display device and the input device into one device, may be used without departing from the scope of the invention.

The order processor, which is coupled to the user interface, books orders for proposed trades responsive to activation of the input device by the Customer to select a price or size selector. If the Customer activates the input device to select a price selector, the order processor will book the order using the Customer-specified order size and an order price equal to the quoted price represented by the selected price selector. In preferred embodiments, the Customer may also use the input device to activate a size selector shown in the trading panel (instead of activating a price selector). Typically, the Customer will activate a size selector because all of the quotes received are insufficient quotes and the system has been configured to display and visibly distinguish the best insufficient quotes. In this case, the order processor will book the order using the quoted size represented by the selected size selector instead of the Customer-specified order size. The order processor will also use the Provider's quoted price. The result is that the Customer is able to book an order using an order size that is less than the order size originally specified by the Customer, but which, upon the Customer's consideration, may still meet or advance a Customer objective.

In some embodiments, booking the order may involve automatically completing several steps, such as generating an offer to deal, sending the offer to deal to the selected Provider, receiving a confirmation from the Provider that the Provider has accepted (or rejected) the terms of the offer to deal (or executed the order) and booking (i.e., recording) the trade as being complete.

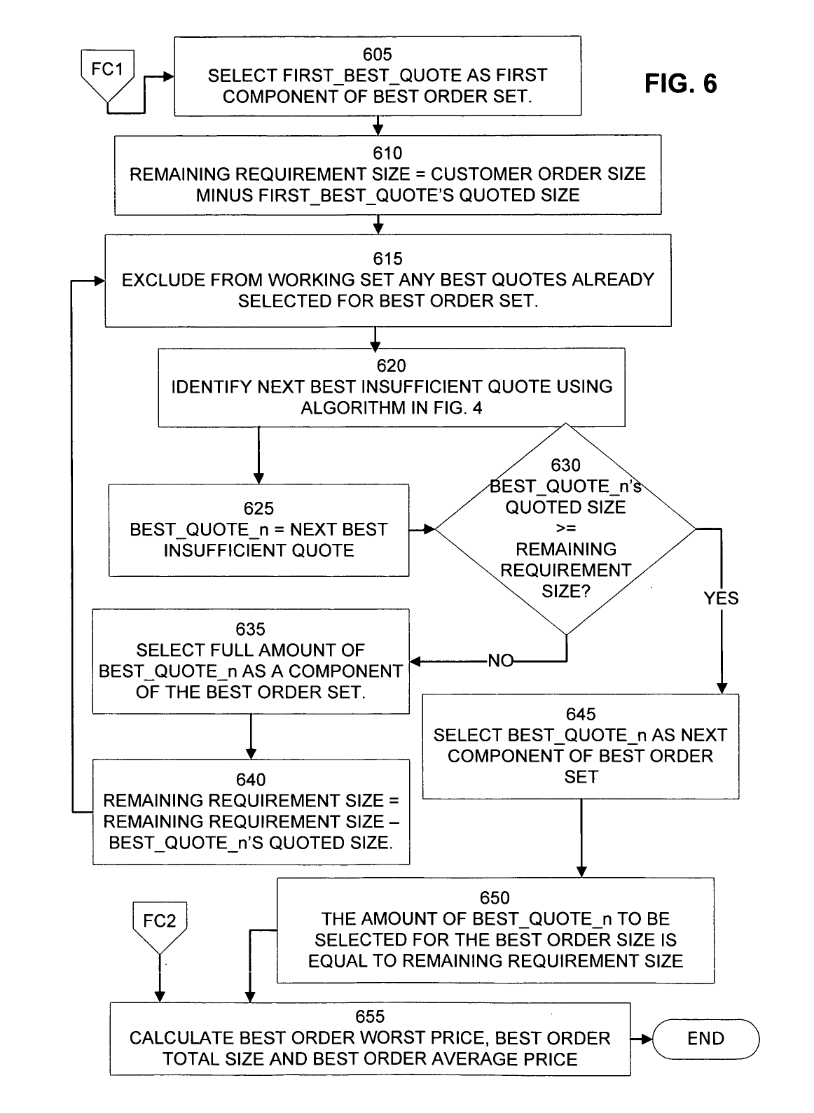

In preferred embodiments, the display screen generator also displays on the display device a quote panel (an example of such a quote panel is shown in FIG. 6 and discussed in detail below). In the quote panel, Customers may view selectors representing the best dealable quotes for a plurality of proposed trades (such as, for example, eight proposed trades for eight different currency pairs) simultaneously. For each proposed trade, there is displayed in the quote panel a selector representing the best bid and ask prices available to meet the Customer's desired order size. Preferably these prices are displayed and updated in real time. The Customer can submit a buy or sell order by selecting a price selector associated with a desired price quote. The selection may be made via a variety of well-known input device selection techniques, such as single- or double-clicking a mouse, for example.

In preferred embodiments, the display screen generator and input device are configured to provide control over a quote panel and trading panel that are cooperatively linked to each other such that Customers can show the trading panel associated with a particular proposed trade (e.g., a proposed transaction involving a particular currency pair), for example, by single-clicking on an input field or selector in the quote panel. In such embodiments, the invention stores and maintains in a memory the data necessary to display a different trading panel for each proposed trade in a plurality of pending proposed trades and to switch rapidly from one trading panel to the next responsive to the Customer's selection or manipulation of input fields, selectors, icons or menus displayed in the quote panel.

Notably, while the user interface described above is the preferred embodiment, it is not the only user interface that falls within the scope of the present invention. Using an application programming interface (API) configured to operate according to the streaming protocol described below, customers may construct alternative user interfaces that look substantially different from the user interface described above (because they do not utilize trading or quoting panels, for instance), but which identify and display to users dealable quotes, best dealable quotes and multi-bank best orders.

Trading Protocols

The customer trading system of the present invention includes features that make it much easier and much faster for Customers to identify, review, select and execute the best quotes. Although equally applicable to other trading protocols, the invention is especially useful to Customers conducting trading transactions using the streaming protocol. For this reason, some of the invention's features and benefits are best illustrated by way of the following detailed discussion, which describes how the invention may be configured to operate in a streaming environment.

Trading protocols are trading transaction workflows. A workflow defines one or more valid sequences of messages exchanged between parties to complete a business transaction. Non-limiting examples of standard asset trading protocols with which the present invention may be configured to operate include the protocols known in the asset trading business as “Request for Quotes (RFQ),” “Streaming,” “Resting Orders,” “Order Book” and “Fill-or-Kill.” The present invention may also be configured to operate with certain non-standard trading protocols, including “QuickFill,” “QuickTrade,” “QuickBatch” and “Post Trade Deal Completion and Modification,” which are examples of FX trading protocols offered by FXall.

As stated in the background section above, the RFQ protocol is a trading protocol whereby the Customer initiates a trade by asking one or more Providers for a price quote on a particular asset. The Provider responds by providing one or more quotes and the Customer takes advantage of the quotes by sending the Provider an offer to deal. Typically, the transaction is completed when the Provider responds to the offer to deal with an acceptance or a rejection.

In a QuickTrade transaction, the Customer typically opens a user input dialogue box (known in the asset trading business as a “deal ticket”) and enters certain trading details for the proposed transactions, such as the currency pair, amount, value date and choice of Providers. The Customer then submits these details to a transaction server and quotes from the selected Providers appear in the QuickTrade deal ticket. To deal, the Customer clicks on the price from one of the Providers. A QuickBatch transaction extends the QuickTrade functionality by allowing the Customer to combine trade requirements spanning any combination of currency pairs, value dates and accounts into a single deal ticket. The full set of requirements can be sent to Providers for pricing with a single click by the Customer, and a Provider's quotes may be subsequently accepted with a second click by the Customer.

When trading transactions are conducted using the streaming protocol, Providers continuously stream executable price quotes to Customers instead of waiting for the customer to send a Request For Quote. Having continuous access to multiple streams of executable quotes from multiple Providers enables Customers to essentially “watch” the market as it moves and immediately submit offers when they see one or more quotes that meet their particular asset type, price and size requirements.

Characteristics of Trading Sessions Using the Streaming Protocol

Trading sessions conducted using the streaming protocol are typically characterized by at least four operating conditions that are normally not present in trading sessions conducted using other protocols. First, quoting in a streaming trading session may be started automatically when the user logs into the system and stopped automatically when the user logs off. Second, quoting in a streaming protocol trading session may be initiated without reference to a specific trade amount or trade direction (the trade direction specifies whether the customer wishes to buy or sell assets). Instead, the user may specify these details separately when submitting an offer to deal. Third, although the Customer may have specified a maximum order size at the beginning of the trading session, a different order size may be specified each time the Customer submits an offer to deal against a quote. Thus, the order size used for executing a deal may be very different from the maximum order size the Customer specified at the beginning of the trading session. And fourth, quoting usually continues even after the Customer submits an offer to deal, which allows the Customer to quickly submit additional offers to deal for subsequently received quotes without having to generate and send new requests for quotes.

Messaging Protocol

Customer asset trading systems configured to operate according to the present invention exchange trading instruction messages with remote Provider asset trading systems and/or intermediate asset trading servers using data communications channels established within an interconnected computer network, such as a wide area network (WAN), a corporate intranet or the Internet. Preferably, these messages are exchanged according to a defined messaging protocol, which takes into account the special operating conditions of the trading protocol being used. In preferred embodiments, the messaging protocol used by the present invention has five stages, each stage defining a set of messages that may be sent or received by the counterparty systems during that stage. The five stages are described below.

Stage 1: Request For Quote. The Customer's trading system generates and sends to one or more Provider trading systems an “RFQ” message asking Providers to start sending quotes for a desired currency pair. Included in the message is the maximum order size, which gives the Provider an indication of how large an order the customer expects to submit. Thus, the maximum order size may tell the Provider whether the user expects a quote valid up to $1 mio, $10 mio or $100 mio, for example. This stage is usually initiated automatically when the user opens or logs into the Customer trading system. Each Provider may optionally acknowledge the quote request by sending an “Inclined To Quote” message.

Stage 2: Quoting or Withdrawing Stage. Each Provider trading system will normally respond to the RFQ by sending to the Customer's trading system a stream of quotes, each quote having a quoted price and a quoted size (the quoted size being the maximum order size for which the quote is valid). Providers may publish bid quotes, ask quotes, or two-way (bid/ask) quotes. Optionally, the Provider may temporarily withdraw a quote at any time by sending a “Quote Withdrawn” message. In embodiments of the present invention, receiving a “Quote Withdrawn” message from the Provider trading system causes the Customer trading system to erase (or blank out) the current quote for that Provider on the Customer's display device. Preferably, quotes are displayed to the Customer on the Customer's display device in the order they are received from the Providers.

Stage 3: Offer To Deal Stage. When the Customer wishes to deal, he or she submits an “Offer to Deal” message by selecting a quoted price or a Provider. Sending an offer to deal in this fashion constitutes a firm order to buy or sell an amount of assets equal to the customer order size at the selected quoted price. The Customer may also enter a customer order size into the user interface. This is the size that will be submitted with the next offer to deal. In embodiments of the invention, and as described below, the customer order size may be changed at any time during the trading session. In preferred embodiments, the customer order size may not be larger than the quoted size offered by the selected Provider. The Customer may also select a quoted size received from a Provider. Selecting a quoted size constitutes a firm order to buy or sell an amount of assets equal to the selected quoted size (as opposed to the Customer-specified order size) at the quoted price. The Customer also may specify or select an account against which the order will be booked. The user interface (described in detail below) has many features designed to make sending an Offer to Deal message very fast and very easy for the Customer.

Stage 4. Accept Terms/Reject Terms Stage. Upon receipt of the “Offer To Deal” message, the Provider trading system will usually send to the Customer's trading system either an “Accept Terms” message to indicate that it has accepted and booked the Customer's full order at the quoted price, or a “Reject Terms” message to indicate that the Customer's full order was rejected and the deal has not been executed. In some embodiments, the Provider's trading system will send the acceptance or rejection to a centralized trading platform, such as the platform provided by FXall, which in turn sends the acceptance or rejection to the Customer's trading system. In some embodiments, the trading systems and centralized trading platform also may be configured so that the Provider must either execute the full order size or reject the entire order. Alternatively, the trading systems and centralized trading platform may be configured so that the Provider may partially fill the Customer's order (that is, execute on a smaller size than the customer requested).

Stage 5: Terminated/Denied Stage. The Provider may permanently withdraw from the RFQ at any time by sending a “Quote Denied” message. In preferred embodiments, the invention may be configured to send the “Quote Denied” message automatically when the Provider logs out. The Customer may permanently withdraw from the RFQ at any time by sending a “Quote Terminated” message. In preferred embodiments, the invention may be configured to send the “Quote Terminated” message automatically when the Customer logs out.

The messaging protocol described above is meant to be illustrative. Customer trading systems configured to operate according to the present invention may use messaging protocols having more or fewer stages, messaging protocols that have a different ordering for the stages, or overlapping stages, depending on the particular circumstances and the particular trading requirements of the overall trading network, without departing from the scope of the claimed invention.

Functional Components of a Preferred Embodiment

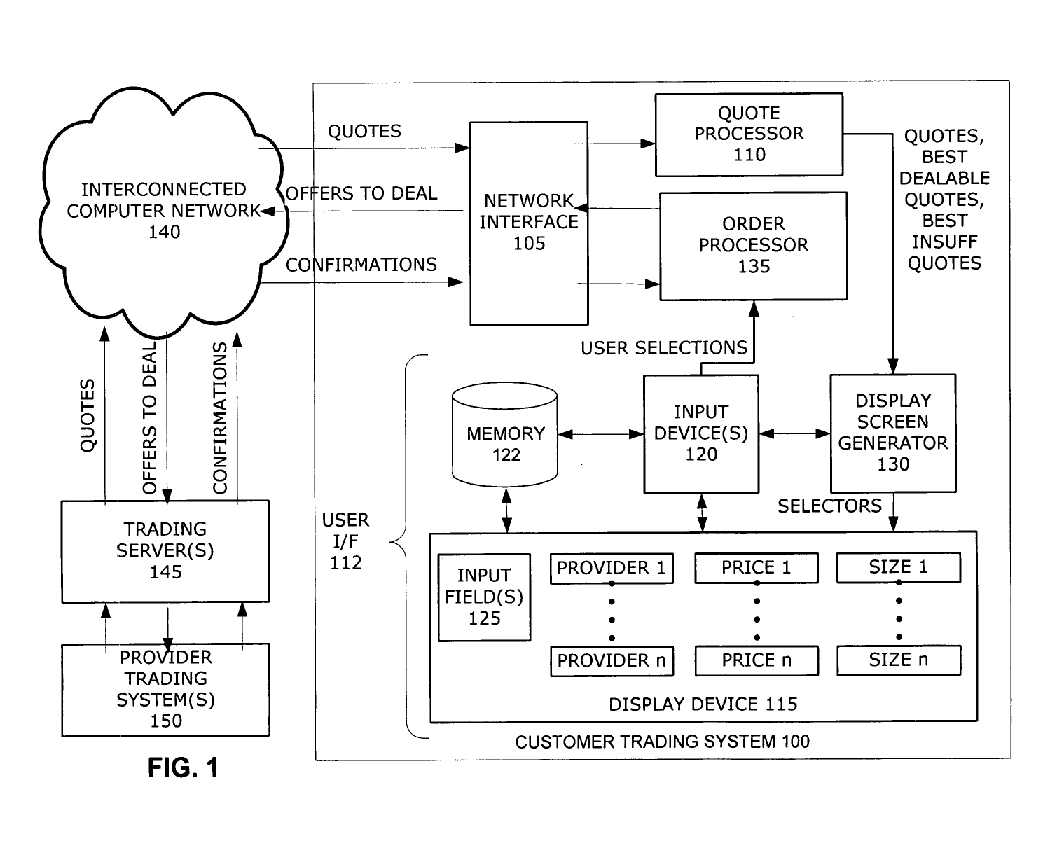

FIG. 1 shows a high-level block diagram of the major functional components of a customer trading system configured to operate according to an illustrative embodiment of the present invention. As shown in FIG. 1, customer trading system 100 comprises a network interface 105, quote processor 110, user interface 112 and order processor 135. Customer trading system 100 may be coupled, via network interface 105, to any interconnected computer network, such as the Internet (represented by interconnected computer network 140 in FIG. 1), which is in turn coupled to trading server(s) 145 and provider trading system(s) 150. For simplicity and ease of understanding, FIG. 1 shows provider trading system(s) 150 as being directly linked to trading server(s) 145. It should be understood, however, that trading server(s) 145 and provider trading system(s) 150 may in fact be indirectly linked through another interconnected computer network (not shown in FIG. 1) or even the same interconnected computer network shown in FIG. 1 as interconnected computer network 140. In any case, the interconnected computer network or networks to which customer trading system 100, trading server(s) 145 and provider trading system(s) 150 are connected, may be configured for wired data communications, wireless data communication, or both.

Network interface 105, which may comprise, for example, any wired or wireless network interface adapter, is configured to receive, via interconnected computer network 140, a plurality of quotes (or quote streams) associated with one or more proposed trades from each of a plurality of Provider trading system(s) 150. In this context, a proposed trade comes into existence, for example, when a Customer issues an RFQ (a request for individual or streaming quotes) to execute a financial transaction using a particular currency pair or a particular set of currency pairs. In preferred embodiments, the RFQ is issued automatically when a user logs into customer trading system 100. Preferably, although not necessarily, the RFQ is transmitted along with a maximum order size desired by the Customer through an input device or by means of a default order size that may be stored in one or more customer profiles residing on customer trading system 100, trading server(s) 145, provider trading system(s) 150, or all three of these systems.

Each quote in the plurality of quotes received from the Providers contains at least a quoted price and a quoted size for which the quoted price is valid. In the foreign exchange context, a quoted price may comprise a number such as 1.2507, for example, and a quoted size may comprise a number such as $10 mio. Taken together, these numbers may indicate that the Provider supplying the quote is willing to buy up to 10 million U.S. dollars at a price of 1.2507 U.S. dollars per Euro.

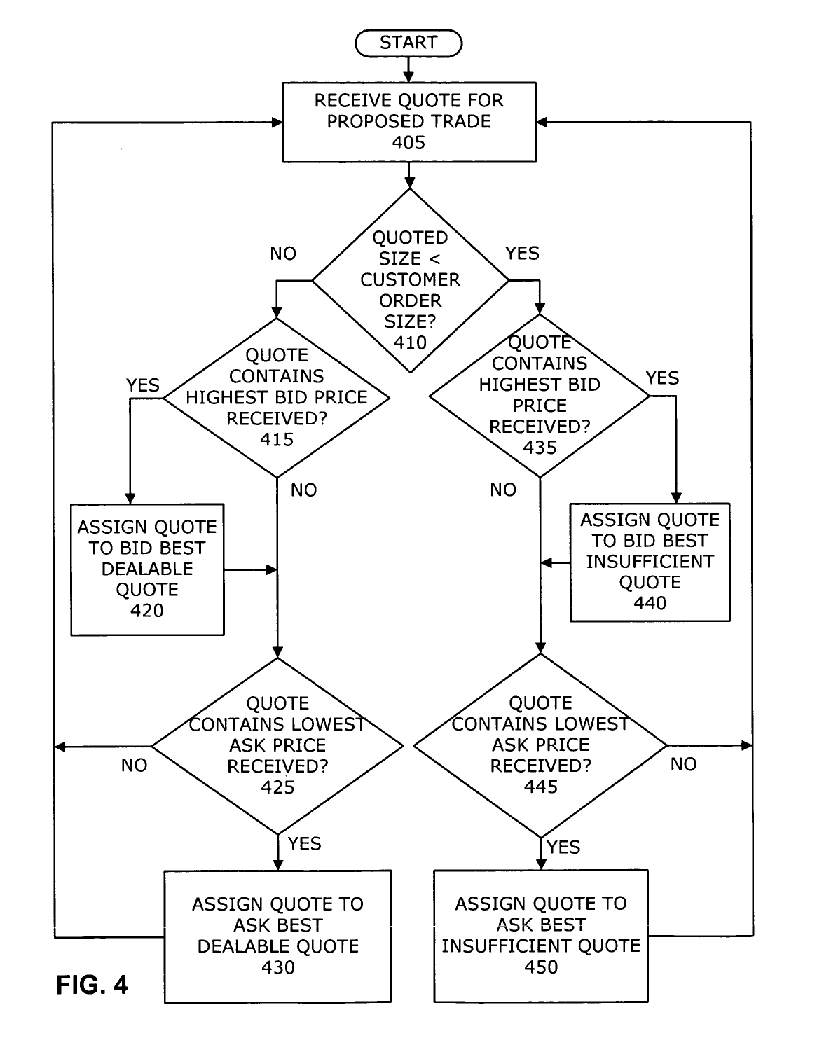

Network interface 105 passes the plurality of Provider-supplied quotes to Quote processor 110, which identifies a set of dealable quotes in the plurality of quotes. Quote processor 110 may be implemented by programming a general-purpose computer, a software program, a microprocessor, or any combination of one or all of the above, to perform the steps outlined in the discussion that follows below with reference to FIG. 4. The set of dealable quotes (which may in fact be a null set if no dealable quotes are received), contains each quote in the plurality of quotes that has a quoted size that is not less than (i.e., greater than or equal to) the customer-specified order size for the proposed trade. If any dealable quotes are received, quote processor 110 will identify the “best dealable” quote in the plurality of quotes according to an algorithm such as the one described below with reference to FIG. 4. If no dealable quotes are received, quote processor 110 identifies the best insufficient quotes. A best insufficient quote is a quote in the plurality of quotes received from Providers having a quoted size that is less than the customer-specified order size and greater all of the other quoted sizes in the plurality of quotes.

The system may be configured to automatically identify the best dealable quotes for each trading direction. In the case where the Customer wishes to purchase assets, the best dealable quote is the one that has a quoted price that is less than or equal to every other quoted price in the set of dealable quotes. On the other hand, if the Customer wishes to sell assets, the best dealable quote is the quote that has a quoted price that is greater than or equal to every other quoted price in the set of dealable quotes.

After quote processor 110 identifies the best dealable and/or best insufficient quotes, all of the quotes are passed to user interface 112, which is configured to display the quotes to the user in a manner designed, according to principles of the invention, to make it very easy and efficient for the Customer to visually inspect the quotes and quickly submit orders on the best quotes. Accordingly, user interface 110 comprises display device 115 for displaying information to the Customer, input device 120 for manipulation by the Customer to select or specify certain choices and trading instructions, and display screen generator 130, which accepts the quotes from quote processor 110 and uses the information to generate the screens and panels that will be displayed to the user on display device 115. Typically, user interface 112 is implemented by means of an application programming interface (API), containing a library of subroutine and function calls, which serve to establish and control data communications in the computer network, as well as exchange trading data (i.e., messages) with trading server 205.

Display device 115 may comprise any standard computer monitor or display screen, which may be connected to a mainframe, personal, laptop or handheld computer, or some combination of one or all of the above. Display device 115 may also comprise a display screen on any number of wireless network communication devices, such as a cellular telephone, personal digital assistant or pager, for example. Input device 120 may comprise any standard human interface input device, such as a mouse, stylus, keyboard, trackwheel or trackball.

In preferred embodiments, display screen generator 130 is typically implemented by means of a software program, hardware device or firmware device (or a combination of all three) programmed, using methods known in the art, to generate and display text, graphics, images, icons and menus on a display device, such as display device 115. For purposes of this invention, display screen generator 130 is programmed to generate and display on display device 115 a user input field (input field 125 in FIG. 1), which is configured to receive input from the Customer, such as the customer order size, responsive to the Customer's manipulation of input device 120.

Display screen generator 125 is also configured to display on display device 115 a trading panel (an example of which is shown in detail in FIG. 5) comprising a plurality of price selectors (shown in FIG. 1 as “Price 1” through “Price n”) and a plurality of size selectors (shown as “Size 1” through “Size n”). Each price selector represents a quoted price in the plurality of quotes and each size selector represents a quoted size in the plurality of quotes. Preferably, the price and size selectors are displayed along with icons (shown as “Provider 1” through “Provider n” in FIG. 1) indicating which Providers supplied the prices and sizes represented by the price and size selectors. In preferred embodiments of the invention, each size selector shown in the trading panel represents a quoted size equal to the largest order size the Provider will accept for the quoted price.

To make it easy for the Customer to identify and submit orders for the best quotes, the price selectors for the best dealable quotes (or the best insufficient quotes if no dealable quotes are received) are visibly distinguished from price selectors for other quotes. Visible distinctions may be achieved, for instance, by programming display screen generator 130 to color, highlight and/or blink the price selectors representing prices for the best dealable and best insufficient quotes, such that they stand out from other price selectors displayed on display device 115.

Order processor 135, which is coupled to network interface 105 and user interface 112, books the proposed trade responsive to activation of input device 120 by the Customer. If the Customer uses input device 120 to select any price selector displayed in the trading panel (e.g., the price selector identified in FIG. 1 as “Price 1”), then order processor 135 will book the order using the customer order size previously supplied by the Customer through input field 125 and an order price equal to the quoted price represented by the selected price selector (i.e., price selector “Price 1”). However, if the Customer uses input device 120 to select a size selector displayed in the trading panel (e.g., the size selector identified in FIG. 1 as “Size 1”), then order processor 135 will book the order using the quoted size represented by the selected size selector (i.e., size selector “Size 1”) and the corresponding Provider price (i.e., “Price 1”).

Order processor 135 may be configured to book the order only after generating and sending to the Provider an offer to deal on the selected quote and receiving an “Accept Terms” message from the selected Provider responsive to the offer to deal. Alternatively, the system (or the network in some instances) may be configured to book orders automatically without waiting for the Provider to send an “Accept Terms” message. In both cases, order processor 135 sends offers to deal to provider trading system(s) 150 via network interface 105, interconnected computer network 140 and trading server(s) 145.

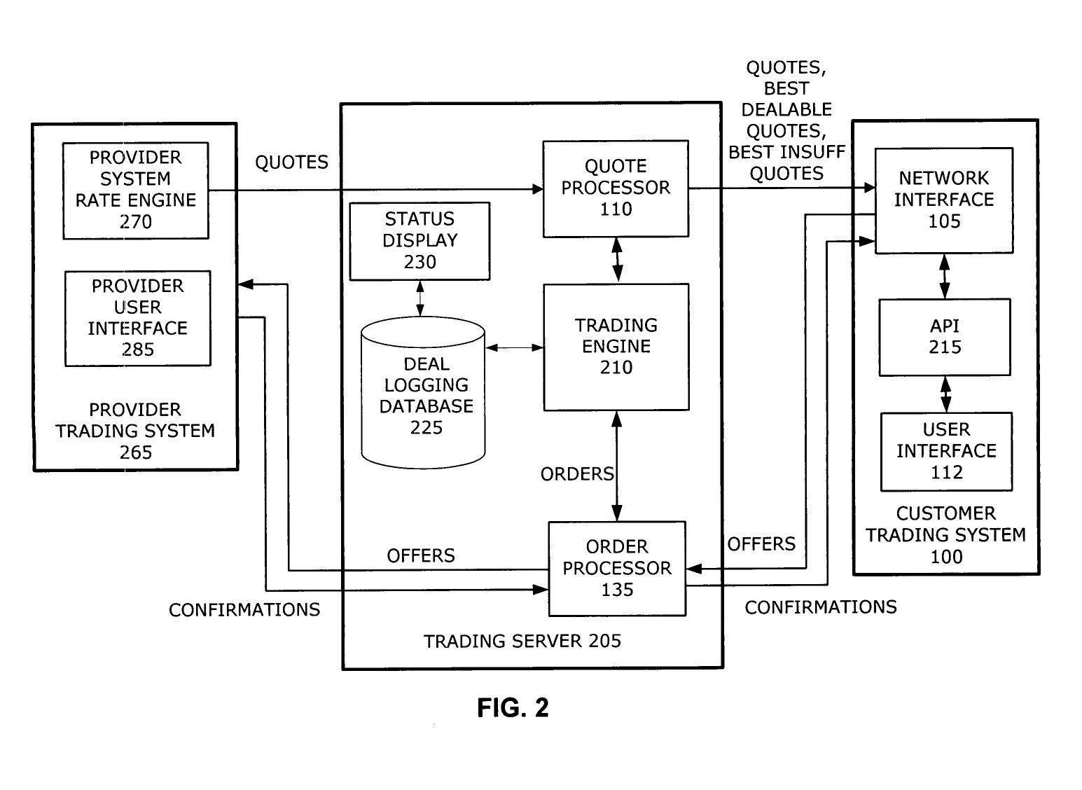

In some embodiments, quote processor 110 and order processor 135, or certain functions performed by quote processor 110 and order processor 135, may be duplicated, or otherwise entirely implemented, on a computer system in the network other than customer trading system 100, such as, for example, on centralized trading server(s) 145 or provider trading system(s) 150. Such a configuration is discussed below with reference to FIG. 2.

The plurality of quotes received from the Providers through network interface 105 may be associated with more than one (or a multiplicity) of proposed trades. If this is the case, quote processor 110 in preferred embodiments is configured to identify a group of best dealable quotes comprising at least one best dealable quote (and possibly two best dealable quotes—one for each trade direction) for each proposed trade in the plurality of proposed trades. Moreover, display screen generator 130 is configured to display on display device 115 a quote panel (an example of which is shown in FIG. 6) comprising a plurality of best dealable quote selectors, each representing a best dealable quote for one proposed trade in the plurality of proposed trades.

When the Customer uses input device 120 to select any best dealable quote selector from the plurality of best dealable quote selectors shown in the quote panel, order processor 135 will book an order using the customer order size previously provided by the Customer through input field 125 and the quoted price associated with the best dealable quote represented by the selected best dealable quote selector. In preferred embodiments, the quote panel and the trading panel are displayed on display device 115 simultaneously and the quote panel contains a proposed trade selector (i.e., a user-activatable icon or button) for each proposed trade in the plurality of proposed trades. If the Customer uses input device 120 to activate any one of the proposed trade selectors, display screen generator 130 will display in the trading panel the price selectors and size selectors that are associated with the proposed trade represented by the activated proposed trade selector.

In some embodiments, initiating and terminating quoting occurs automatically when the Customer logs in or logs out, respectively, of customer trading system 100. In alternative or modified embodiments, display screen generator 130 may be configured to display on display device 115 an icon, control or menu item comprising a quote stream “switch,” which the Customer can use to send a message to initiate or terminate quoting.

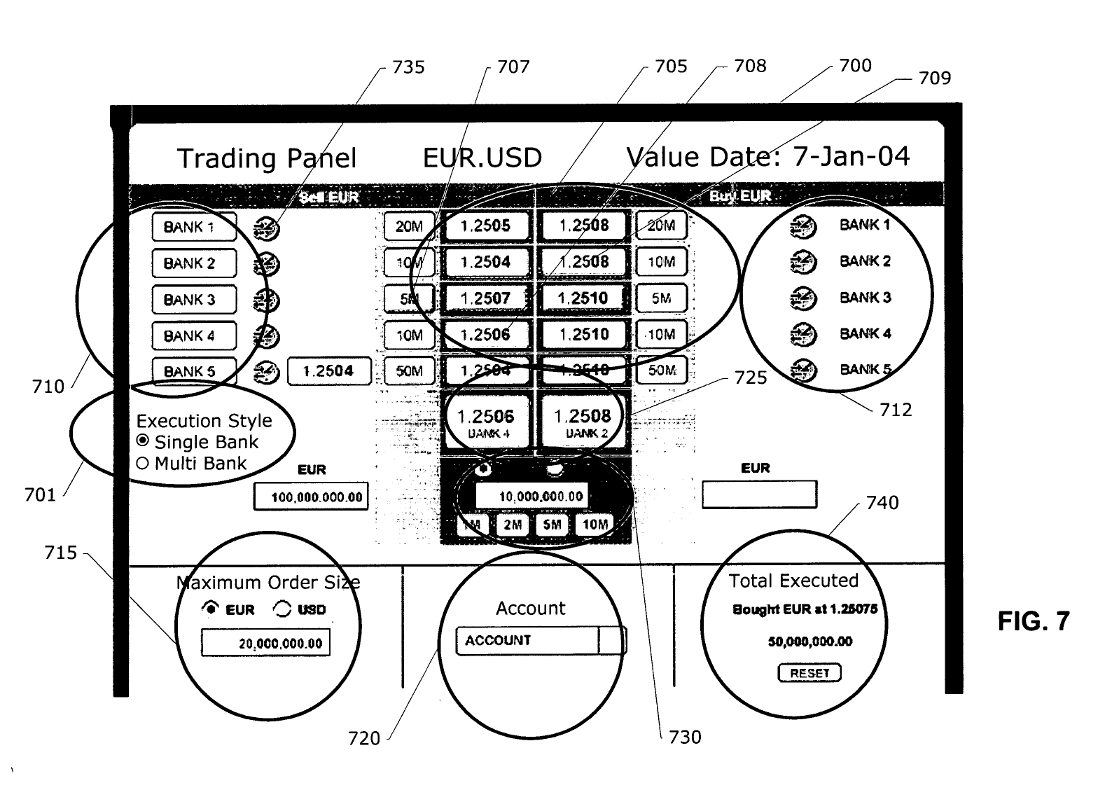

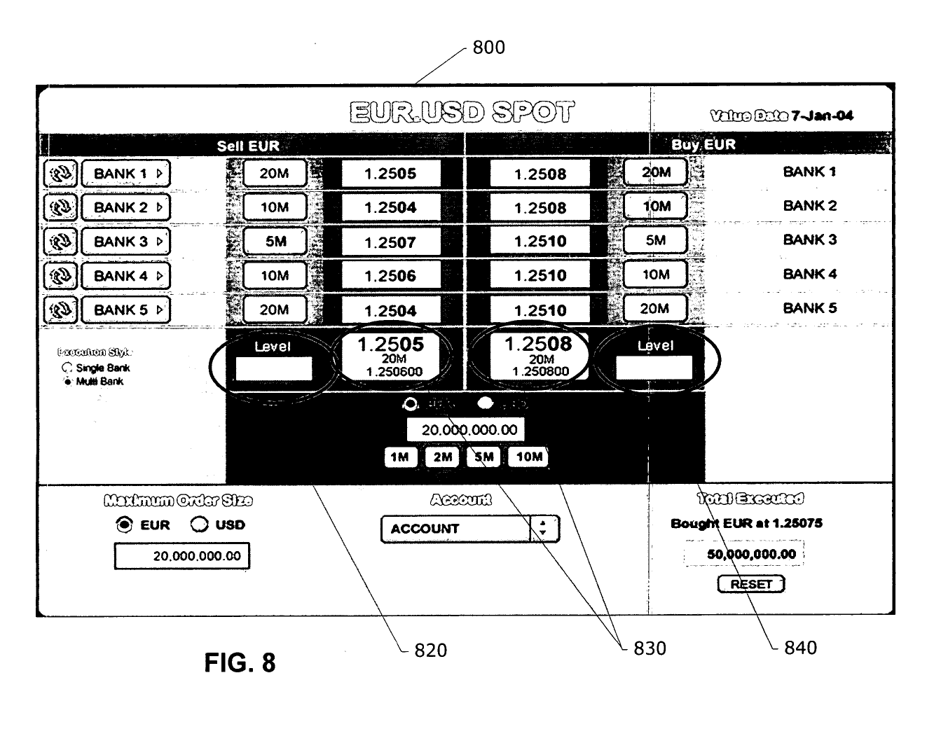

Display screen generator 130 may also display on display device 115 a second input field (not shown in FIG. 1) configured to receive from the Customer a maximum order size. If the Customer uses input device 120 to specify such a maximum order size, then quote processor 110 and/or display screen generator 130 may be configured to ignore or discard Provider quotes having quoted sizes greater than the specified maximum order size. Display screen generator 130 may also be configured to generate and display on display device 115 an account identifier field (not shown in FIG. 1) configured to receive from the Customer an account identifier for the proposed trade. Examples of input fields configured to receive the maximum order size and the account identifier are shown in FIGS. 7 and 8, which are discussed below.

In preferred embodiments, Customer trading system 100 also includes one or more memory devices, such as hard drives, removable storage or random access memory devices, which are configured to store data supplied by the customer via input device 120, such as the customer order size, or data generated by order processor 135, quote processor 110 and/or display screen generator 130, such as the plurality of quotes received from the Providers through network interface 105 and the group of best dealable quotes displayed in the quote panel.

The present invention may be implemented in any distributed computer network environment, such as a wide area network (WAN), local area network (LAN), a corporate intranet, a dedicated extranet or the Internet. FIG. 2 shows an alternative embodiment of the present invention in which quote processor 110 and order processor 135 reside on centralized trading server 205. Customer trading system 100 is coupled, via an interconnected computer network (not shown in FIG. 2), to trading server 205, which is coupled to provider trading system 265.

In the embodiment shown in FIG. 2, the components of customer trading system 100, including network interface 105 and user interface 112, operate substantially the same as described above and with reference to FIG. 1. As shown in FIG. 2, user interface 112 may be configured to communicate with trading server 205 by calls to API 215, which passes data and requests to trading server 205 via network interface 105. API 215 comprises a library of function calls and subroutines configured to accept commands and arguments from user interface 112. In preferred embodiments, user interface 112 is configured to generate or obtain a protocol-dependent workflow conforming to the characteristics of the streaming protocol as described above. User interface 112 then builds a defined sequence of protocol-independent fundamental asset trading messages, called “gestures.” The gestures are then successively transmitted to trading server 205 via the subroutine and function calls in API 215. Protocol-independent gestures are a component of the inventions disclosed and claimed in a co-pending application filed on even date herewith, entitled “PROTOCOL-INDEPENDENT ASSET TRADING SYSTEM AND METHODS” (Ser. No. ______), which is assigned to the assignee of the present application and incorporated in its entirety into this application by this reference.

Unlike the embodiment of the invention discussed above with reference to the drawing of FIG. 1, however, the quote processing functions (e.g., identifying dealable, insufficient, best dealable and best insufficient quotes) and the order processing functions (e.g., generating offers to deal and booking proposed trades responsive to activation of selectors displayed on the Customer's display device) are performed on trading server 205. Accordingly, quote processor 110 and order processor 135 are shown in FIG. 2 to reside on trading server 205 and not on customer trading system 100. As shown in FIG. 2, trading server 205 also may include a trading engine 210, which matches offers to deal with quotes, a database (deal logging database 225) for logging deal details, and a status display (status display 230), where an administrator may monitor trades between Customers and Providers. Other functional components of the central trading server (not shown in FIG. 2), such as entitlements, security, market reference and customer reference databases, may also be included in trading server 205. Preferred configurations of Provider trading system 265 include a provider system rate engine 270, which generates quotes and quote streams for proposed trades, and a provider user interface 285, which the Provider uses to review offers to deal, send confirmations and review the status of pending quotes and orders.

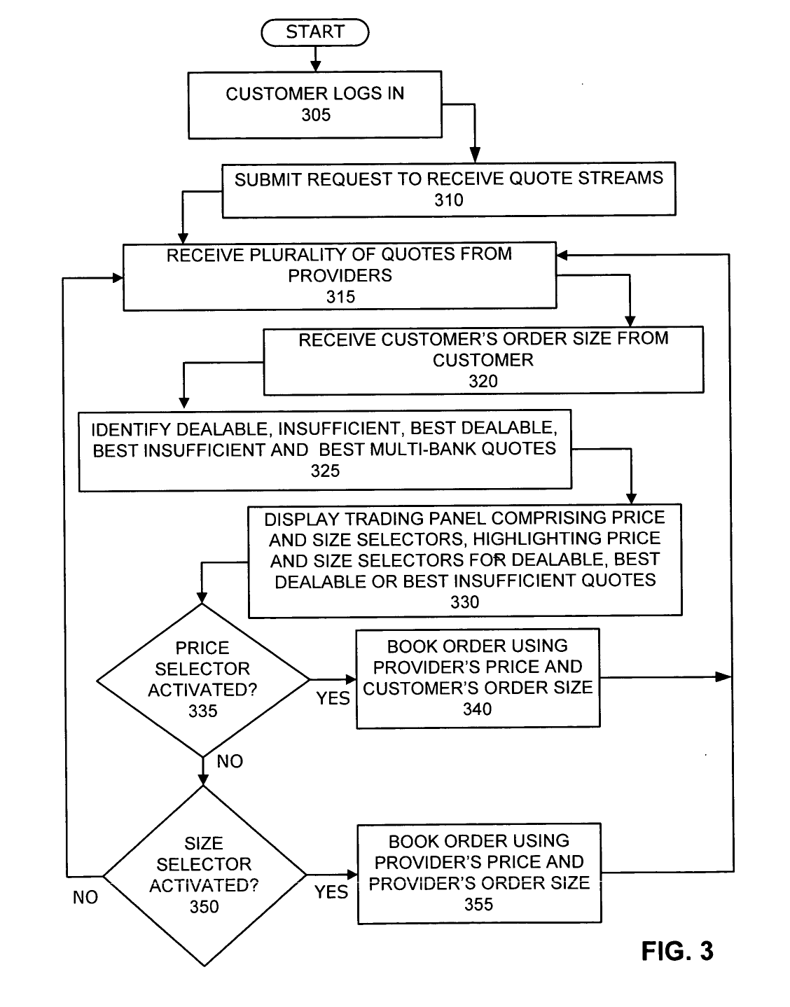

FIG. 3 contains a flow diagram illustrating, at a high level, the major steps typically performed by embodiments of the present invention, such as the customer trading systems described above with reference to FIGS. 1 and 2, to implement a quick-filling customer asset trading system. After the Customer logs into the system (shown as step 305 in FIG. 3), the system submits to Providers a request to receive quote streams (see step 310). As stated above, this step may be performed automatically by the system or, alternatively, in response to the Customer activating a control displayed on his or her display device after logging in. Next, in steps 315 and 320, respectively, the system receives quotes from Providers in response to the request, and an order size from the Customer. Notably, steps 315 and 320 may be performed in the reverse order or simultaneously without departing from the scope of the claimed invention. Next, at step 325, the system, or, more particularly, a quote processor in the system, identifies the dealable, insufficient, best dealable and best insufficient quotes from among the plurality of quotes received. If the system is operating in multi-bank execution mode, the system also, or in some cases, alternatively, identifies a best multi-bank order comprising a combination of single-bank insufficient quotes from multiple Providers. Exemplary algorithms suitable for performing these identifications are provided in FIGS. 4, 5 and 6, which are discussed in more detail below. Based on these identifications, a display screen generator, such as display screen generator 130 in FIG. 1, displays a trading panel to the user comprising price and size selectors, which represent Provider quoted prices and quoted sizes. Price and size selectors for dealable, best dealable and best insufficient quotes are highlighted for the user in order to facilitate selection by the Customer of the best quotes (step 330). In systems having the multi-bank execution mode functionality, the trading panel may also contain and/or highlight a best multi-bank order selector. Alternatively, price selectors for quotes that are not dealable may be “grayed out,” which informs the user that such selectors are not selectable because of their non-dealable status.

Next, at step 335, the system determines whether the Customer has selected any of the price selectors displayed in the trading panel on the display device. If so, the order processor books an order using the order size specified at step 320 and the quoted price represented by the selected price selector (step 340). If not, the system next determines, at step 350, whether the Customer has activated any of the size selectors displayed on the display device. If any size selector has been activated, then the order processor books the order using an order size equal to the quoted size represented by the selected size selector and a price equal to the Provider's price associated with the selected order size (step 355). If no size selector has been activated, the processing returns to step 315, where the system receives and begins processing additional quotes. As discussed above, booking the order may comprise a four-step procedure of generating an offer to deal, sending the offer to deal to the selected Provider, receiving a confirmation that the Provider has accepted the terms (or executed) of the offer to deal and actually booking (or logging) the deal. In some embodiments, the system may be configured to simply submit offers to deal at steps 340 and 355, instead of actually booking orders. In such embodiments, further steps, such as receiving a Provider confirmation, may be required before orders are booked.

Provider Quote Processing

Provider Quotes are the quotes sent (either individually or as part of a continuous stream of quotes) by Providers in response to Customer RFQs or requests to start streaming. In preferred embodiments of the invention, a Provider quote contains a quoted price and a quoted size for which the quoted price is valid. Providers may transmit bid quotes, ask quotes, or bid/ask (two-way) quotes.

In preferred embodiments, customer trading systems operating according to the invention classify Provider quotes into at least two categories: “dealable” quotes and “insufficient” quotes. These two categories of Provider quotes are described below in Table 1.

TABLE 1
Provider Quote Categories

| Quote Type | Description |
|---|---|
| Dealable | The Provider has sent a quote wherein the quoted size |
| | component of the quote equals or exceeds the |
| | customer order size. |
| Insufficient | The Provider has sent a quote wherein the quoted size |
| | component of the quote is less than the customer |
| | order size. |

Depending on the circumstances and requirements of the particular trading environment desired, more or fewer categories of Provider quotes may be called for and utilized in any particular embodiment of the invention to achieve some or all of the advantages described herein. It may be necessary, desirable or advantageous, for example, to define numerous other categories of Provider quotes to describe the responses (and/or lack of responses) Providers send (or fail to send) after the customer trading system issues an RFQ or request to start streaming quotes. Examples of three such optional categories are shown in Table 2 below.

TABLE 2
Optional Provider Quote Categories

| Category | Description |
|---|---|
| Unmapped | The Provider has returned a quote in response to the |
| | customer's RFQ or stream request. However, the |
| | provider has not “mapped” the account selected by |
| | the Customer for the next order (Account mapping is |
| | described below). |
| Unquoted | The Provider currently does not have a live quote in |
| | response to the customer's RFQ or stream request. |
| | Either the Provider has explicitly withdrawn a |
| | previous quote or the Provider has not yet responded |
| | to the customer's RFQ or stream request. However, |
| | the Provider has not exited from the quote stream, so |
| | it is possible that the Provider will subsequently send |
| | a quote. The Provider may or may not have mapped |
| | the account selected by the Customer. |
| Stopped | The Provider has stopped sending quotes (i.e., |
| | terminated the quote stream). Therefore, there are |
| | currently no quotes available from the Provider and |
| | no chance that the Provider will subsequently send a |
| | quote unless the quote stream is restarted in response |
| | to a new RFQ, for example. The Provider may or may |
| | not have mapped the account selected by the user. |

After reviewing this specification, it should be apparent to those skilled in the art that the optional categories shown in Table 2 may be particularly useful in network operating environments, such as the one depicted in FIG. 2 and described above, where there is an intermediate or centralized trading platform or server performing administrative functions such as monitoring, matching, logging and documenting messages and trading instructions exchanged between counterparty Customer and Provider trading systems.

Account Mapping

The Customer and Provider trading systems may use different account identifiers for the same trading account. In this case, the trading platform or server typically maintains a “mapping” between the account identifier used by the Customer and the account identifier used by the Provider. For example, the Customer may specify a particular trading account by entering “PENSION FUND 1” in the account identifier field in the trading panel (see FIGS. 7 and 8). But the Provider may refer to the same account as “BF0123”. In order for trades executed on this account to be booked automatically by the intermediate trading server or the Provider's trading system, both systems must be made aware that the identifier PENSION FUND 1 should be mapped to the account referred to as BF0123. Conversely, in order for trades executed on this account to be booked automatically by the Customer's trading system, the Customer's trading system must be made aware that the identifier BF0123 should be mapped to the account it knows as PENSION FUND 1. Thus, one or more of the trading systems and servers in the network operating environment, or all of them, may be configured so that there is a mapping between “PENSION FUND 1” and “BF0123.” With this mapping functionality in place, when the Customer trading system is manipulated by the Customer to designate the account “PENSION FUND 1” as the trading account, the account identifier code “BF0123” is sent to the Provider trading system (or, as the case may be, to the centralized trading server) so that the trade can be automatically booked for the designated account.

Receiving Provider Quotes

When the Customer trading system receives Provider quotes, the quoted sizes are compared to the customer order size. If the quoted size and the customer order size are specified in different currencies, the size specified in the base currency is converted to the terms currency before making the comparison by multiplying the quoted size by the quoted price. If the quoted size and the customer order size are specified in the same currency, no conversion is necessary, and the sizes are compared directly. The system then identifies the Provider quotes that are dealable (if any) and those that are insufficient. One method of identifying dealable and insufficient quotes is discussed below with reference to FIG. 4. Both dealable and insufficient quotes may be displayed on the user's display device.

Identifying Dealable, Best Dealable and Best Insufficient Quotes

When Provider quotes are received, the system determines, for each currency pair and each direction, which (if any) of the quotes received are dealable. Then the system identifies, for each currency pair and each direction, the best dealable quotes received. If no dealable quotes are received, the system determines whether any insufficient quotes were received and, if so, identifies the best insufficient quotes. Dealable quotes, best dealable quotes and best insufficient quotes are visibly distinguished from all of the other quotes when they are displayed on the user's display device. One algorithm that may be used to identify the dealable, best dealable and best insufficient quotes is discussed below and illustrated in the flow diagram shown in FIG. 4. This algorithm may be performed, for example, by Quote Processor 110, which is discussed above with reference to FIGS. 1 and 2.

As shown in FIG. 4, the first step is to receive a quote for a proposed trade (step 405). Next, at step 410, the system determines whether the quote received is dealable or insufficient based on a comparison of the quoted size with the Customer-specified order size. If the quoted size is less than the customer-specified order size, then the quote is insufficient and processing continues at step 435 to determine whether the insufficient quote is one of the best insufficient quotes. However, if it is determined at step 410 that the quoted size is not less than the customer-specified order size, then the quote is dealable and the system will proceed to step 415 in FIG. 4 to determine, based on the quoted price, whether the quote is a best dealable quote.

A bid price specifies the price a Provider is willing to pay for an asset. Therefore, the bid best dealable quote for a proposed trade is the dealable quote with the numerically highest bid price. Accordingly, processing continues at step 415, where the system compares the quoted bid price in the current dealable quote with the quoted bid prices of one or more quotes previously-received. If the current quote contains a quoted bid price that is higher than the quoted bid prices of all previously-received bid dealable quotes, then, at step 420, the current quote is assigned to (or marked as) the bid best dealable quote. Since it is possible to receive a quote that has the same bid price as a quote previously marked as the quote with the best bid price, preferred embodiments of the invention will include one or more tie resolution policies. One arbitrary way to resolve ties (among many possible tie resolution policies), for example, is to use the quote that arrived first as the bid best dealable quote. In other words, a previously-received quote that has been marked as the bid best dealable quote will remain the bid best dealable quote until another quote is received that has a higher price. Alternatively, the Customer may have previously supplied a ranking of the Providers, and the ranking can be used to resolve any ties.

Next, the system must determine whether the current quote contains the ask best dealable quote. Since an ask price specifies the price a Provider is willing to sell an asset, the ask best dealable quote for a proposed trade is the dealable quote with the numerically lowest ask price. Accordingly, at step 425, the system compares the quoted ask price in the current dealable quote with the quoted ask prices of the previously-received ask best dealable quotes. If the current quote contains an ask price that is lower than the ask prices of all previously-received ask best dealable quotes, then the current quote is assigned to (or marked as) the ask best dealable quote (step 430). Again, ties may be resolved by using the quote that arrived first and discarding quotes that merely tie a previously-received ask best dealable quote. Next, processing returns to step 405, where another quote is received and processed to determine its status.

Depending on the quoted sizes in a plurality of received quotes, there may be no dealable quotes for a proposed trade and, consequently, no best dealable quote. Or, there might be a best dealable quote on one side of the market (e.g., the bid side) but not the other (e.g, the ask side). In addition, it is possible that the bid and ask best dealable quotes may be submitted by different Providers.

Trading systems configured to operate according to the present invention also identify and visibly distinguish on the user's display device the best insufficient quotes received from the Providers for each currency pair and each trading direction. Continuing to refer to FIG. 4, if it is determined at step 410 that the current quote contains a quoted size that is less than the customer-specified order size, then the quote is insufficient. The next step then is to determine whether the insufficient quote is a best insufficient quote.

The bid best insufficient quote is the insufficient bid quote with the numerically highest bid price. Therefore, the system determines, at step 435, whether the bid price for the current insufficient quote is higher than the bid prices for all previously-received best insufficient quotes. If so, then the current insufficient quote is marked as the bid best insufficient quote (step 440). If not, the previously-received best insufficient quote continues to be marked as the best insufficient quote and the system determines, at step 445, whether the current quote has the numerically lowest ask price. If so, then the current quote is marked as the ask best insufficient quote (step 450). Here again, ties may be resolved by selecting the quotes that arrived first or using a Provider ranking previously supplied by the Customer.

Depending on the quoted sizes, there may be no best insufficient quote for a proposed trade. For example, all of the quotes received may be dealable. It is also possible to for there to be a best insufficient quote on one side of the market (e.g., the ask side) but not the other (e.g., the bid side). The bid and ask best insufficient quotes also may belong to different Providers.

The algorithm shown in FIG. 4 and discussed above comprises only one example of potentially many different algorithms and many different resolution policies the system may be configured to implement to determine best dealable and best insufficient quotes and resolve ties. For example, as an alternative to the resolution policies described above, the system may be configured to choose the winning quote (in the case of tie) based on a Customer's ranking of preferred Providers.

Determining the Best Order Set

The best order for a plurality of quotes is the combination of quoted sizes and quoted prices from the Providers which: (1) in a partial order, supplies the highest proportion of the customer's order size; and (2) in a full order, supplies the best overall price. FIGS. 5 and 6 contain an algorithm which may be used in embodiments of the invention to determine the best quotes and the best proportions of the quoted sizes in those best quotes to use in forming the best order. This algorithm ensures that liquidity at the best price is used first, then liquidity at the next best price, and so on, until the customer-specified order size has been allocated.

Beginning with FIG. 5, the first step is to collect all of the insufficient quotes to form a working set (step 505). Quotes in other quote categories (e.g., unquoted, unmapped, stopped and invalid quotes, for example) are ignored. Next, the system determines, at step 510, whether the Customer has supplied bid or ask limits. If so, any quotes outside the bid or ask limits specified by the customer or removed or excluded from the working set (see step 515). More specifically, if a bid limit is set, then any bid quotes having quoted prices that are numerically lower than the specified bid limit are excluded from the working set. If an ask limit is set, then any ask quotes having quoted prices that are numerically higher than the specified ask limit are excluded from the working set.

Next, processing continues at step 520, where the quoted sizes of all the quotes in the working set are summed and stored in a placeholder (in this case, a variable called “Quotesum”) for future calculations. This is done independently for both the bid and ask sides. At step 525, the value of Quotesum is compared to the customer order size. If the value of Quotesum is less than or equal to the customer order size, then the best order set contains all insufficient quotes in the working set. Moreover, the full amount of each quote in the working set is selected to be part of the best order (see step 530 of FIG. 5). At this point, processing continues at step 655 of FIG. 6 (discussed below) by way of flow chart connector FC2. If, on the other hand, it is determined at step 525 that the value of Quotesum is greater than the Customer order size, the system will automatically determine the best insufficient quote in the working set, preferably by using the algorithm illustrated by the flow diagram shown in FIG. 4. This step is shown in FIG. 5 at step 535. After the first best insufficient quote is determined, it is stored in a placeholder (in this case, a variable called “First_Best_Quote”) for future calculations (see step 540).

Next, as shown in FIG. 5 at step 545, the quoted size of the First_Best_Quote is compared to the Customer order size. If quoted size of First_Best_Quote is greater than or equal to the Customer order size, then the best order set is composed solely of the First_Best_Quote and the amount of First_Best_Quote selected for the best order size is equal to the Customer order size. Thus, if the quoted size of the First_Best_Quote is 20 million units, and Customer order size is 10 million units, then only the first 10 million units of the First_Best_Quote will be put into the best order set. When the best set is determined, processing continues at step 655 of FIG. 6 (discussed below) by way of flow chart connector FC2. If, on the other hand, it is determined at step 545 that the quoted size of the First_Best_Quote is less than Customer order size, then processing continues at step 605 of FIG. 6 by way of flowchart connector FC1.

Referring now to FIG. 6, at step 605, the First_Best_Quote is selected as a component of the best order set (as opposed to the entire best order set) because the order size of First_Best_Quote is less than the order size requested by the customer. Then the remaining requirement size (the amount needed to completely fill the Customer's order) is determined by subtracting the quoted size of First_Best_Quote from the Customer order size (see step 610). Next, the system determines the next best insufficient quote in the working set. This is accomplished by first excluding any quotes that have already been selected for the best order set (e.g., the First_Best_Quote) and then using the algorithm in FIG. 4 again to determine the best insufficient quote (see steps 615 and 620). The next best insufficient quote is then stored in another placeholder (in this case, a variable called “Best_Quote_n”) for future calculations as described below (step 625). At step 630, the quoted size of Best_Quote_n is compared to the remaining requirement size. If the quoted size of Best_Quote_n is less than the remaining requirement size, then Best_Quote_n is selected as the next component of the best order set, and the full amount of Best_Quote_n is selected for the best order set (step 635). In other words, if the quoted size for Best_Quote_n is 10 million units, and the remaining requirement size is 20 million units, then the entire amount of Best_Quote_n's quoted size (all 10 million units) is selected for the best order. Next, at step 640, a new remaining requirement size is calculated by subtracting Best_Quote_n's quoted size from the original remaining requirement size. Processing then returns again to steps 615 and 620, where the system again excludes any quotes already selected for the best quote set and identifies yet another best insufficient quote using the algorithm shown in FIG. 4. Thus, the loop defined by steps 615, 620, 625, 630, 635 and 640 will execute repeatedly until the quoted size of a best insufficient quote becomes greater than the remaining requirement size.

If it is determined at step 630 that the quoted size of Best_Quote_n is greater than or equal to the remaining requirement, then Best_Quote_n is selected as the next component of the best order set. However, only a portion of Best_Quote_n, that portion being equal to the remaining requirement size, is put into the best order set (see step 650). In other words, if the quoted size of Best_Quote_n is 25 million units, but the remaining requirement is only 15 million units, then the portion of Best_Quote_n's quoted size used to fill the best order will be the first 15 million units.

Finally, after the best order set is completely determined, the system will calculate and show to the user certain information about the best order (step 655). In preferred embodiments, this information includes the best order worst price, the best order total size and the best order average price. The best order worst rate is the numerically lowest bid and/or the numerically highest ask price for all of the selected quotes. The best order total size is the sum of all the selected sizes in the currency specified by the Customer order size. The best order average rate is the sum of the terms currency of all the selected quotes, divided by the sum of the base currency of all selected rates.

Trading Panel (Single-Bank Execution Mode)

FIG. 7 shows an exemplary screen shot of a trading panel that may be drawn on the display device, according to an embodiment of the invention, when the invention is operating in single-bank execution mode. As shown in the embodiment in FIG. 7, trading panel 700 comprises several display regions containing user input controls Customers may use to perform trading-related actions, such as submitting offers to deal, specifying or changing order sizes and selecting Providers for proposed trades. Region 701, for example, contains radio buttons the Customer may use to select which execution mode (single-bank or multi-bank) to use for the proposed transaction.

The trading panel shows a detailed view of quotes received for a proposed trade for a single currency pair (in this case, EUR.USD). The trading panel also shows the current quote from each Provider together with the largest order size available from the Provider. Provider price selectors and associated quoted size selectors are displayed to the Customer in the four columns in the region of FIG. 7 generally designated 705. Reading from left to right, the four columns in region 705 contain: Bid Quoted Sizes; Bid Quoted Prices; Ask Quoted Prices; and Ask Quoted Sizes. The Bid Quoted Sizes column contains size selectors representing Provider bid quoted sizes, which is the size of the liquidity available from each Provider. In the example in FIG. 7, Bank 1, Bank 2, Bank 3, Bank 4 and Bank 5 are willing to buy euros in sizes of 20 million, 10 million, 5 million, 10 million and 50 million, respectively. The fourth column, which is the Ask Quoted size column, contains ask quoted sizes for each of the Providers identified in the region 712. Thus, Bank 1, Bank 2, Bank 3, Bank 4 and Bank 5 are also willing to sell euros in sizes of 20 million, 10 million, 5 million, 10 million and 50 million, respectively. In preferred embodiments, the sizes shown in columns one and four of the region generally designated 705 in FIG. 7 are the largest sizes these Providers are willing to trade at the prices represented by the price selectors shown in columns two and three of region 705. Preferably, the size selectors in columns one and four are highlighted to draw the Customer's attention if the best price in the market is associated with a size that is smaller than the Customer needs. In the example shown in FIG. 7, for instance, button 707 (containing the characters “5M”) would be specially colored, or highlighted in some other fashion, such as with flashing, blinking, over-large or bold characters, to indicate that, although its size (5 million units) is smaller than the customer requested, it is associated with the best price in the market (which, in this case, is 1.2507). Although FIG. 7 shows that the Customer may be allowed to select from five banks, alternative embodiments of the invention may be configured to display any number of banks. For example, the Customer may be allowed to view and select from ten, fifteen or even twenty banks, not just five.

Region 715 contains input fields the Customer may use to specify his or her maximum order size and currency for the trade. Region 720 contains an input field the Customer may use to designate a particular account for the proposed trade. Customers may use these fields to specify the maximum order size so that the Providers can stream the tightest, most appropriate price for the volume requested. Region 725 of the trading panel contains price selectors for the best dealable quotes. And, finally, region 730 contains user input fields configured to receive the Customer's desired order size and currency for the next offer to deal or order the Customer submits.

Provider Selection

The system may be configured so that a number of Provider selection buttons (regions 710 and 712 of FIG. 7) are available. In preferred embodiments, the Provider names displayed in these regions may be changed or amended via a click-open dialogue box configured to list all Providers available for the Customer. Using this dialog box, Customers may also de-select Providers. In some embodiments, the system may be configured so that users can only select Providers with whom they have been authorized to trade. If no Provider is selected for a particular row of price selectors on the screen, then the quoted price and quoted size selectors may not be displayed for that row.

Provider RFQ Refresh

The user may also request a new RFQ to be sent to a Provider by clicking on the quote stream switch (a column of such quote stream switches are indicated with reference number 735 in FIG. 7) adjacent to the provider name button. Upon clicking the refresh button, a new RFQ message is sent to the Providers.

Provider Price and Quoted Size Selectors

In preferred embodiments, colors for the price and quoted size selectors may be configured to conform to a pre-defined user interface coloring scheme, an example of which is described below in the section entitled “User Interface Coloring Conventions.”

Best dealable quoted price selectors are determined by the algorithm discussed above with reference to FIG. 4 and displayed (as shown in region 725) in the Bid Best Quote and the Ask Best Quote columns. In preferred embodiments, and as shown in region 725 of FIG. 7, Provider names are also displayed within the best dealable quote selectors. In the exemplary trading panel shown in FIG. 7, for instance, the bid best dealable quote was submitted by Bank 4 and the ask best dealable quote was submitted by Bank 2 (see region 705). Accordingly, the display screen generator highlights Bank 4's bid price selector (button 708 in the second column of Region 705) and Bank 2's ask price selector (button 709 in the third column of Region 705). In this case, the display screen generator also creates and displays in region 725 additional price selectors for Bank 4's bid price and Bank 2's ask price. Creating and displaying extra price selectors, and highlighting them with special colors or characters makes it even easier for the Customer to spot and execute orders for the best quotes.

The Maximum Order Size and Currency input fields (region 715) are populated with information that will be sent to the Provider in an RFQ message to indicate the maximum size on which the Customer expects to submit an order or an offer to deal. The system may be configured so that Providers are free to ignore the maximum order size and can quote on larger or smaller sizes if they wish. The maximum size available for an actual order is limited only by the Providers' quoted size. The specified currency (to which the Maximum Order Size applies) is typically selectable through radio buttons. Usually, although not necessarily, the base currency is displayed first followed by the terms currency.

Typically, the account input field (region 720 in FIG. 7) may be manipulated via a drop down menu. In preferred embodiments, the drop down menu lists available accounts in alphabetic order. The customer order size and currency fields (region 730) allow the Customer to specify the currency and order size that will be submitted for the next offer to deal. The buttons in region 730 (containing the text “1M,” “2M,” “5M” and “10M”) are called “QuickSize” buttons, and they provide single-click customer order size amendment functionality. The values for each button in this region may be defaulted according to a predefined customer preference or profile. Selection of a QuickSize button will populate the customer order size field above the QuickSize buttons with the size defined for the individual QuickSize button. Thus, the amount requested may be changed without restarting the Provider's quote streams.

The display field in region 740 displays to the customer the total amounts executed, as well as the average rate.

FIG. 8 shows an exemplary screen shot of a trading panel as it might be drawn on the display device when the invention is operating in multi-bank execution mode. Most of the buttons, icons, selectors and switches shown in the multi-bank execution mode trading panel depicted in FIG. 8 operate the same way they do in the single-bank execution mode trading panel shown in FIG. 7. However, the multi-bank execution mode trading panel contains a few controls not present in the trading panel used for single-bank execution mode. As indicated in FIG. 8 at reference numbers 820 and 840, for example, the multi-bank execution trading panel contains bid and ask level controls, which can be used by the customer to set bid and ask limits on the quotes to be considered for a best order determination. If such limits are provided, then quotes with prices that fall outside those limits will be excluded from consideration for the best order.

The best order price selectors (indicated by reference number 830 in FIG. 8) represent the best multi-bank order, which is calculated from the current Provider quote using, for example, the algorithm shown in FIGS. 5 and 6 and discussed above. The information displayed on the best order selectors includes the best order worst rate, the best order total size and the best order average rate, which are also determined according to the algorithm shown in FIGS. 5 and 6.

Quote Panel

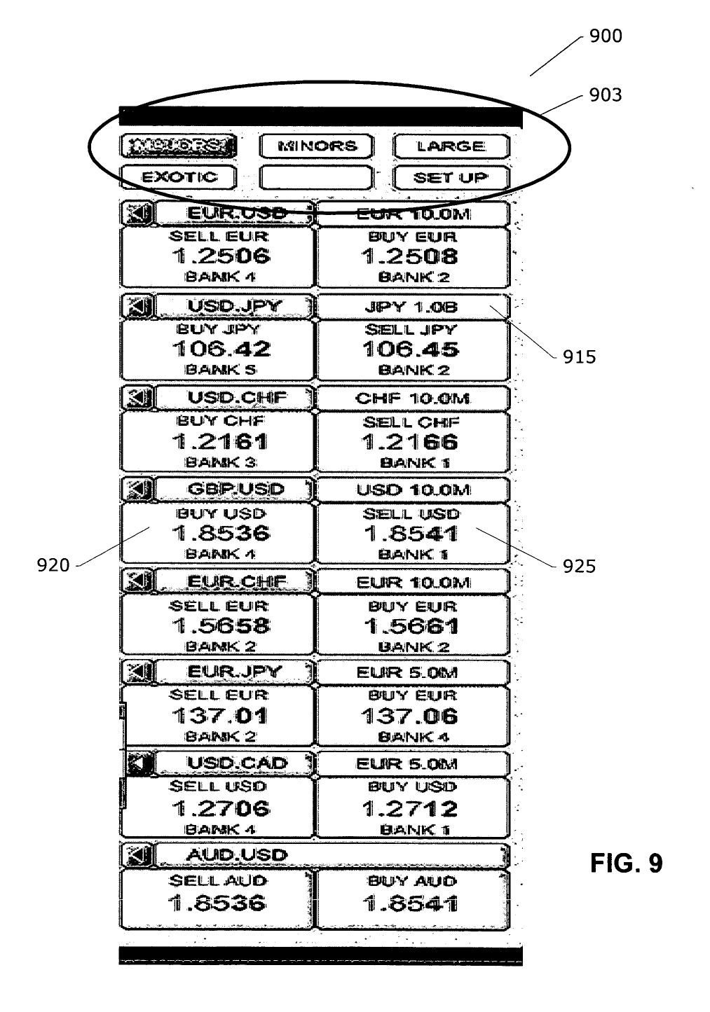

FIG. 9 shows an exemplary screen shot of a quote panel (quote panel 900) that may be drawn on the user's display device in an embodiment of the invention. Customers can use the quote panel to view live prices for a multiplicity of currency pairs simultaneously. For each currency pair, the best bid and ask price available to meet the Customer's order size is displayed in real time, and the Customer can submit a buy or sell order by, for example, double-clicking a mouse button. In preferred embodiments, the system may also be configured to send a QuickTrade RFQ for any of the currency pairs in the panel.

In some embodiments, customers can create multiple quote panels (for example, five quote panels, each having a total of eight currency pairs, for a total of 40 currency pairs), and switch between them with a single- or double-click of the mouse. Quote subscriptions may be maintained for all of the quote panels at all times, so that rates appear instantaneously when the user selects a different panel.

Region 903 in FIG. 9 contains several buttons the Customer may use to select which quote panel to display at any given time. The button for the currently active quote panel may be highlighted in some fashion, such as with a blue background, so that users may identify the name of the currently active quote panel at a glance.

For each currency pair displayed within the quote panel, the following selectors are available. Coloring for these selectors may be made to conform to the formats described in the section entitled “User Interface Coloring Conventions” below.

Best Dealable Quote and Order Size Selectors.

Button 920 in FIG. 9 is a bid best dealable quote selector. Selecting button 620 displays the bid best dealable quote, the Provider and the Customer deal direction. Double-clicking button 920 will submit an offer to deal with the named provider for the order size requested. Button 925 in FIG. 9 is an ask best dealable quote selector. Selecting this button displays the ask best dealable quote, the Provider and Customer deal direction. Double-clicking button 925 will submit an offer to deal with the named provider for the order size requested. Button 915 in FIG. 9 is an order size selector. Selecting an order size selector displays the order size for the order currency. A single click on this button will populate the trading panel with the Provider quotes for the selected currency pair as shown in FIGS. 7 and 8.

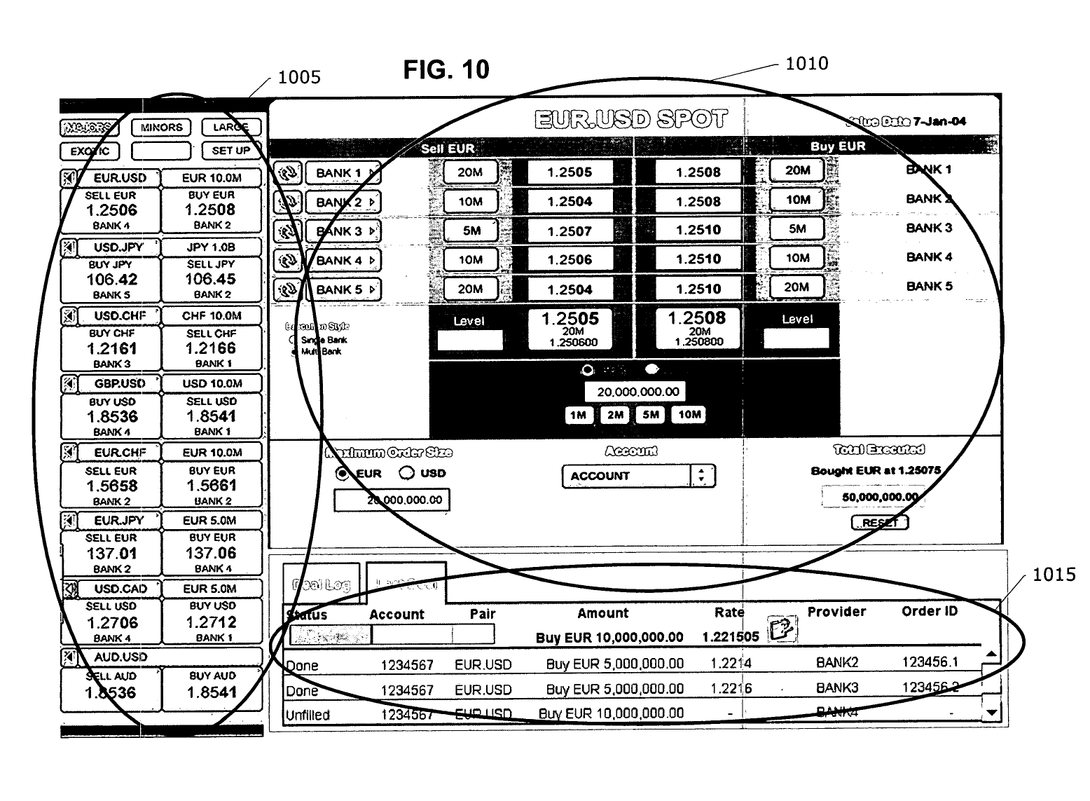

As stated above, the system may be configured so that the trading panel and the quote panel are displayed on the Customer's display device simultaneously. FIG. 10 shows an example of such a simultaneous display. In FIG. 10, the trading panel (generally designated with reference number 1010) is shown on the right side of the display, while the quote panel (generally designated with reference number 1005) is shown on the left side of the display device. FIG. 10 also shows an optional log panel (the region designated with reference number 1015), which shows the status of the user's pending trades.

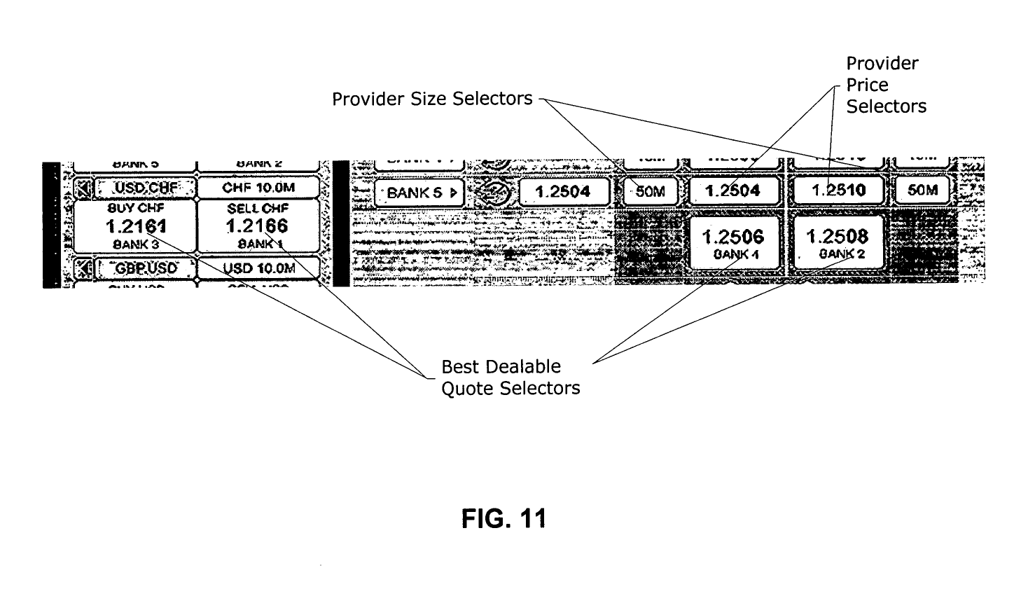

In the embodiment shown in FIG. 10, there are three kinds of selector buttons available to Customers for submitting an offer to deal for each currency pair and direction: provider price selectors, provider size selectors and best dealable quote selectors. FIG. 11 contains a closer view of the portions of the user's display screen containing these three kinds of selectors. Activating one of the provider price selectors submits an offer to deal to the winning Provider for the Customer's order size. These selectors may be disabled (and/or “grayed out”) if the Provider's quote is not dealable. Activating a provider size selector submits an offer to deal to the winning provider for the Provider's quoted size. Typically, these selectors are used to achieve one of two main purposes: (1) execution of the full order size available for one or more insufficient quotes; and (2) immediate execution of larger order sizes offered by Providers. Activation of a best dealable quote selector submits an offer to deal to the Provider behind the best dealable quote for the Customer's order size. The best dealable quote selectors also may be configured to open a QuickTrade ticket for the selected currency pair and order size.

User Interface Coloring Conventions

To enable rapid identification and execution of the different quote options, the following tables contain coloring schemes that may be used in preferred embodiments of the invention to color provider quote and best dealable quote selectors.

Provider Quote selectors may be colored as follows:

TABLE 3
Exemplary Coloring Scheme for Provider Quote Selectors

| Quote Type | Price Button | Size Button |
|---|---|---|
| Best Dealable | Yellow Background | White Background |
| | Bold Foreground | Roman Foreground |
| | Shows Price | Shows Quoted Size |
| (Other) | White Background | White Background |
| Dealable | Roman Foreground | Roman Foreground |
| | Shows Price | Shows Quoted Size |
| Best Insufficient | Grey Background | Red Background |
| | Roman Foreground | Roman Foreground |
| | Shows Price | Shows Quoted Size |
| (Other) | Grey Background | White Background |
| Insufficient | Roman Foreground | Roman Foreground |
| | Shows Price | Shows Quoted Size |

The Best Dealable Quote buttons may be colored and operate as follows:

TABLE 4
Exemplary Coloring Scheme for Best Dealable Quote Selectors

| Situation | Best Dealable Button |
|---|---|
| Best Dealable exists | Yellow Background |
| | Bold Foreground |
| | Shows Best Dealable |
| | Price & Provider |
| Best Dealable does not | Grey Background |
| exist | Roman Foreground |
| Best Insufficient exists | Shows Best Insufficient Price & |
| | Provider |
| No dealable or insufficient | Grey Background |
| prices received | Roman Foreground |
| | Shows “—“ |

The present invention has been disclosed and described herein in what is considered to be its most preferred embodiments. It should be noted that variations and equivalents may occur to those skilled in the art upon reading the present disclosure and that such variations and equivalents are intended to come within the scope of the invention and the appended claims. Therefore, for example, it should be understood by one skilled in the art that the present invention is not limited to foreign exchange transactions, and may be beneficially applied to other types of transactions as described above.

1. A computer system for executing trades, comprising:
a network interface configured to receive a plurality of quotes for a proposed trade, each comprising a quoted price and a quoted size;
a quote processor configured to identify a set of dealable quotes in said plurality of quotes, wherein the quoted size in each quote in said set of dealable quotes is not less than a customer order size for the proposed trade;
a user interface comprising a display device, an input device and a display screen generator, said display screen generator being configured to display on said display device
an input field configured to receive said customer order size from a customer, and
a trading panel comprising a plurality of price selectors, each representing one quoted price in said plurality of quotes, and a plurality of size selectors, each representing one quoted size in said plurality of quotes, wherein price selectors for quoted prices in said set of dealable quotes are visibly distinguished from price selectors for quoted prices not in said set of dealable quotes; and
an order processor, coupled to said user interface, configured to book an order for said proposed trade responsive to activation of said input device by said customer;
wherein activation of said input device to select any price selector in said trading panel causes said order processor to book said order using said customer order size and an order price equal to the quoted price represented by said any price selector.

2. The computer system of claim 1, wherein activation of said input device to select said any price selector causes said order processor to generate an offer to deal prior to booking said order.

3. The computer system of claim 1, wherein activation of said input device to select any size selector in the trading panel causes said order processor to book said order using the quoted size represented by said any size selector.

4. The computer system of claim 1, wherein activation of said input device to select said any size selector causes said order processor to generate an offer to deal prior to booking said order.

5. The computer system of claim 1, wherein said quote processor is further configured to determine a best dealable quote within said set of dealable quotes, said best dealable quote having an ask quoted price that is less than or equal to every other ask quoted price in said set of dealable quotes.

6. The computer system of claim 5, wherein the price selector representing said ask quoted price for said best dealable quote is visibly distinguished from price selectors representing ask quoted prices for dealable quotes other than said best dealable quote.

7. The computer system of claim 1, wherein said quote processor is further configured to determine a best dealable quote within said set of dealable quotes, said best dealable quote having a bid quoted price that is greater than or equal to every other bid quoted price in said set of dealable quotes.

8. The computer system of claim 7, wherein the price selector representing said bid quoted price for said best dealable quote is visibly distinguished from price selectors representing bid quoted prices for dealable quotes other than said best dealable quote.

9. The computer system of claim 1, wherein said plurality of quotes are associated with a plurality of proposed trades.

10. The computer system of claim 9, wherein:
said quote processor is further configured to identify a group of best dealable quotes comprising at least one best dealable quote for each proposed trade in the plurality of proposed trades; and
said display screen generator is further configured to display on said display device a quote panel comprising a plurality of best dealable quote selectors, each representing an individual best dealable quote in said group of best dealable quotes.

11. The computer system of claim 10, wherein activation of said input device by said customer to select any best dealable quote selector from the plurality of best dealable quote selectors causes said order processor to book said order using said customer order size and the individual best dealable quote represented by said any best dealable quote selector.

12. The computer system of claim 10, wherein said display screen generator is further configured to display said quote panel and said trading panel on said display device simultaneously.

13. The computer system of claim 12, wherein
said quote panel further comprises a proposed trade selector, coupled to said input device, said proposed trade selector representing a particular proposed trade from said plurality of proposed trades; and
responsive to manipulation of said input device by said customer to activate said proposed trade selector, said display screen generator is further configured to show in said trading panel price selectors and size selectors for quotes in said plurality of quotes that are associated with said particular proposed trade.

14. The computer system of claim 1, wherein
said display screen generator is further configured to display on said display device a quote stream switch; and
said network interface is further configured to start receiving said plurality of quotes responsive to manipulation of said input device by said customer to activate said quote stream switch.

15. The computer system of claim 14, wherein said network interface is further configured to stop receiving said plurality of quotes responsive to manipulation of said input device by said customer to de-activate said quote stream switch.

16. The computer system of claim 1, wherein said display screen generator is further configured to display on said display device a second input field configured to receive a maximum order size from said customer.

17. The computer system of claim 16, wherein
said quote processor is further configured to disregard quotes in the plurality of quotes having quoted sizes greater than said maximum order size; and
said trading panel does not comprise price selectors or size selectors for said disregarded quotes.

18. The computer system of claim 1, further comprising a memory, coupled to said input field, configured to store said customer order size.

19. The computer system of claim 1, wherein said display screen generator is further configured to display on said display device an account identifier field configured to specify an account identifier for the proposed trade.

20. The computer system of claim 1, wherein said plurality of quotes comprises a continuous stream of quotes.

21. The computer system of claim 1, wherein said set of best dealable quotes is a null set.

22. A computer system for executing trades, comprising:
a network interface configured to receive a plurality of quotes for a proposed trade, each comprising a quoted price and a quoted size;
a quote processor, coupled to said network interface, configured to identify a set of dealable quotes in said plurality of quotes, wherein each quote in said set of dealable quotes has a quoted size that is not less than a customer order size for the proposed trade;
a user interface comprising a display device, an input device and a display screen generator, said display screen generator being configured to display on said display device
an input field configured to receive said customer order size from a customer, and
a trading panel comprising a plurality of price selectors, each representing one quoted price in said plurality of quotes, and a plurality of size selectors, each representing one quoted size in said plurality of quotes, wherein price selectors for quoted prices in said set of dealable quotes are visibly distinguished from price selectors for quoted prices not in said set of dealable quotes; and
an order processor, coupled to said user interface, configured to book an order for said proposed trade responsive to activation of said input device by said customer;
wherein activation of said input device to select any size selector shown in said trading panel causes said order processor to book said order using the quoted size represented by said any size selector.

23. The computer system of claim 22, wherein responsive to activation of said input device to select said any size selector, said order processor is further configured to generate an offer to deal prior to booking said order.

24. The computer system of claim 23, wherein said order processor is further configured to receive a confirmation responsive to said offer to deal, and to book said proposed order responsive to said confirmation.

25. A computer system for executing trades, comprising:
a network interface configured to receive a plurality of quotes for a proposed trade, each comprising a quoted price and a quoted size;
a quote processor configured to identify a best insufficient quote in said plurality of quotes, wherein the quoted size of said best insufficient quote is less than said customer order size and greater than any other quoted size in said plurality of quotes;
a user interface comprising a display device, an input device and a display screen generator, said display screen generator being configured to display on said display device
an input field configured to receive said customer order size from a customer, and
a trading panel comprising a plurality of price selectors, each representing one quoted price in said plurality of quotes, and a plurality of size selectors, each representing one quoted size in said plurality of quotes, wherein the size selector representing the quoted size for said best insufficient quote is visibly distinguished from size selectors representing quoted sizes for quotes other than said best insufficient quote; and
an order processor, coupled to said user interface, configured to book an order for said proposed trade responsive to activation of said input device by said customer;
wherein activation of said input device to select any size selector causes said order processor to book said order using the quoted size represented by said any size selector.

26. The computer system of claim 25, wherein activation of said input device to select said any size selector causes said order processor to generate an offer to deal using the quoted size represented by said any size selector.

27. The computer system of claim 25, wherein said quote processor is further configured to identify a best order based on at least two best insufficient quotes, each one of said at least two best insufficient quotes being received from a different provider.

28. The computer system of claim 27, wherein
said trading panel further comprises a best order selector representing said best order; and
activation of said input device to select said best order selector causes said order processor to book at least two orders, each one based on one of said at least two best insufficient quotes.

29. A computer-implemented method for executing trades, comprising:
receiving, via a network interface, a plurality of quotes for a proposed trade, each comprising a quoted price and a quoted size;
receiving, via an input field, a customer order size;
identifying a set of dealable quotes in said plurality of quotes, wherein the quoted size in each quote in said set of dealable quotes is greater than or equal to said customer order size;
displaying on a display device a trading panel comprising a plurality of price selectors, each representing one quoted price in said plurality of quotes, and a plurality of size selectors, each representing one quoted size in said plurality of quotes, wherein price selectors for quoted prices in said set of dealable quotes are visibly distinguished from price selectors for quoted prices not in said set of dealable quotes; and
responsive to activation of an input device to select any price selector in said trading panel, booking an order using said customer order size and an order price equal to the quoted price represented by said any price selector.

30. The method of claim 29, further comprising generating an offer to deal prior to booking said order.

31. The method of claim 29, wherein said plurality of quotes is associated with a plurality of proposed trades.

32. The method of claim 29, further comprising determining a best dealable quote within said set of dealable quotes, said best dealable quote having a quoted price that is less than or equal to every other ask quoted price in said set of dealable quotes.

33. The method of claim 32, further comprising visibly distinguishing the price selector representing the ask quoted price for said best dealable quote from the price selectors representing ask quoted prices for dealable quotes other than said best dealable quote.

34. The method of claim 29, further comprising determining a best dealable quote, said best dealable quote having a bid quoted price that is greater than or equal to any other quoted price for every other bid quoted price in said set of dealable quotes.

35. The method of claim 34, further comprising visibly distinguishing the price selector representing the bid quoted price for said best dealable quote from price selectors representing bid quoted prices for dealable quotes other than said best dealable quote.

36. The method of claim 32, wherein said plurality of quotes is associated with a plurality of proposed trades.

37. The method of claim 36, further comprising:
identifying a group of best dealable quotes comprising at least one best dealable quote for each proposed trade in the plurality of proposed trades; and
displaying on said display device a quote panel comprising a plurality of best dealable quote selectors, each representing an individual best dealable quote in said group of best dealable quotes.

38. The method of claim 37, further comprising booking said order using said customer order size responsive to activation of said input device by said customer to select a best dealable quote selector from the plurality of best dealable quote selectors.

39. The method of claim 37, further comprising displaying said quote panel and said trading panel on said display device simultaneously.

40. The method of claim 39, further comprising
displaying in said quote panel a proposed trade selector representing a particular proposed trade from said plurality of proposed trades; and
responsive to manipulation of said input device by said customer to activate said proposed trade selection switch, showing in said trading panel price selectors and size selectors for quotes in said plurality of quotes that are associated with said particular proposed trade.

41. The method of claim 29, further comprising
displaying on said display device a quote stream switch; and
initiating receipt of said plurality of quotes responsive to manipulation of said input device by said customer to activate said quote stream switch.

42. The computer system of claim 41, further comprising terminating receipt of said plurality of quotes responsive to manipulation of said input device by said customer to de-activate said quote stream switch.

43. The method of claim 29, further comprising displaying on said display device a second input field configured to receive a maximum order size from said customer.

44. The method of claim 43, further comprising:
disregarding quotes in the plurality of quotes having quoted sizes greater than said maximum order size; and
displaying said trading panel without displaying price selectors and size selectors for said disregarded quotes.

45. The method of claim 29, further comprising storing said customer order size in a memory.

46. The method of claim 29, further comprising displaying on said display device an account identifier field configured to specify an account identifier for the proposed trade.

47. The method of claim 29, wherein said plurality of quotes comprises a continuous stream of quotes.

48. The method of claim 29, wherein said set of best dealable quotes is a null set.

49. A computer-implemented method for executing trades, comprising:
receiving, via a network interface a plurality of quotes for a proposed trade, each comprising a quoted price and a quoted size;
receiving, via an input field, a customer order size for the proposed trade from a customer;
identifying a set of dealable quotes within said plurality of quotes, wherein the quoted size of each quote in said set of dealable quotes is not less than said customer order size;
displaying on a display device a trading panel comprising a plurality of price selectors, each representing one quoted price in said plurality of quotes, and a plurality of size selectors, each representing one quoted size in said plurality of quotes, wherein price selectors for quoted prices in said set of dealable quotes are visibly distinguished from price selectors for quoted prices not in said set of dealable quotes; and
responsive to activation of an input device to select any size selector, booking an order using an order size equal to the quoted size represented by said anysize selector.

50. The method of claim 49, further comprising generating an offer to deal prior to booking said order.

51. The method of claim 50, further comprising receiving a confirmation responsive to said offer to deal.

52. A computer-implemented method for executing trades, comprising:
receiving, via a network interface, a plurality of quotes for a proposed trade, each comprising a quoted price and a quoted size;
receiving, via an input field, a customer order size;
identifying a best insufficient quote in said plurality of quotes, wherein the quoted size of said best insufficient quote is less than said customer order size and greater than any other quoted size in said plurality of quotes;
displaying on a display device a trading panel comprising a plurality of price selectors, each representing one quoted price in said plurality of quotes, and a plurality of size selectors, each representing one quoted size in said plurality of quotes, wherein the size selector representing the quoted size for said best insufficient quote is visibly distinguished from size selectors representing quoted sizes for quotes other than said best insufficient quotes; and
responsive to activation of an input device to select any size selector in said trading panel, booking an order using the quoted size represented by said any size selector.

53. A computer system for executing trades, comprising:
means for receiving a plurality of quotes for a proposed trade, each comprising a quoted price and a quoted size;
means for identifying a set of dealable quotes in said plurality of quotes, wherein the quoted size in each quote in said set of dealable quotes is not less than a customer order size for the proposed trade;
a user interface comprising a display device, input means for receiving customer input, including said customer order size;
means for storing said customer order size;
means for displaying on said display means a trading panel for the proposed trade comprising a plurality of price selectors, each representing one quoted price in said plurality of quotes, and a plurality of size selectors, each representing one quoted size in said plurality of quotes, wherein price selectors for quoted prices in said set of dealable quotes are visibly distinguished from price selectors for quoted prices not in said set of dealable quotes; and
means, responsive to activation of said input means to select any price selector, for booking an order using said customer order size and an order price equal to the quoted price represented by said any price selector.

54. The computer system of claim 53, wherein said plurality of quotes is associated with a plurality of proposed trades.

55. The computer system of claim 53, further comprising means for determining a best dealable quote within said set of dealable quotes, said best dealable quote having an ask quoted price that is less than or equal to every other ask quoted price in said set of dealable quotes.

56. The computer system of claim 55, further comprising means for visibly distinguishing the price selector representing said ask quoted price for said best dealable quote from price selectors representing ask quoted prices for dealable quotes other than said best dealable quote.

57. The computer system of claim 53, further comprising means for determining a best dealable quote within said set of dealable quotes, said best dealable quote having a bid quoted price that is greater than or equal to every other bid quoted price in said set of dealable quotes.

58. The computer system of claim 57, further comprising means for visibly distinguishing the price selector representing said bid quoted price for said best dealable quote from price selectors representing bid quoted prices for dealable quotes other than said best dealable quote.

59. The computer system of claim 55, wherein said plurality of quotes are associated with a plurality of proposed trades.

60. The computer system of claim 59, further comprising:
means for determining a group of best dealable quotes, said group of best dealable quotes comprising at least one best dealable quote for each proposed trade in the plurality of proposed trades; and
means for displaying on said display device a quote panel comprising a plurality of best dealable quote selectors, each representing an individual best dealable quote in said group of best dealable quotes.

61. The computer system of claim 60, further comprising means, responsive to activation of said input means by said customer to select any best dealable quote selector from the plurality of best dealable quote selectors, for booking said order using said customer order size and the individual best dealable quote represented by said any best dealable quote selector.

62. The computer system of claim 60, further comprising means for displaying said quote panel and said trading panel on said display means simultaneously.

63. The computer system of claim 62, further comprising
proposed trade selection means for selecting a particular proposed trade from said plurality of proposed trades; and
responsive to manipulation of said input means by said customer to activate said proposed trade selection means, means for showing in said trading panel price selectors and size selectors associated with said particular proposed trade.

64. The computer system of claim 53, further comprising means for requesting delivery of said plurality of quotes.

65. The computer system of claim 64, further comprising means for terminating delivery of said plurality of quotes.

66. The computer system of claim 53, further comprising means for displaying on said display device a second input field configured to receive a maximum order size from said customer.

67. The computer system of claim 66, wherein
said means for identifying said set of dealable quotes is further configured to disregard quotes in the plurality of quotes having quoted sizes greater than said maximum order size; and
said trading panel does not comprise price selectors or size selectors for said disregarded quotes.

68. The computer system of claim 53, further comprising means for storing said customer order size.

69. The computer system of claim 53, further comprising means for specifying an account identifier for the proposed trade.

70. The computer system of claim 53, wherein said plurality of quotes comprises a continuous stream of quotes.

71. The computer system of claim 53, wherein said set of best dealable quotes is a null set.

72. A computer system for executing trades, comprising:
means for receiving a plurality of quotes for a proposed trade, each comprising a quoted price and a quoted size;
means for identifying a set of dealable quotes within said plurality of quotes, wherein the quoted size for each quote in said set of dealable quotes is not less than a customer order size for the proposed trade;
a user interface comprising a display device, input means for receiving input from a customer, including said customer order size;
means for storing said customer order size;
means for displaying on said display device a trading panel for the proposed trade comprising a plurality of price selectors, each representing one quoted price in said plurality of quotes, and a plurality of size selectors, each representing one quoted size in said plurality of quotes, wherein price selectors for quoted prices in said set of dealable quotes are visibly distinguished from price selectors for quoted sizes not in said set of dealable quotes; and
means, responsive to activation of said input means to select any size selector, for booking an order using an order size equal to the quoted size represented by said any size selector.

73. A computer system for executing trades, comprising:
means for receiving a plurality of quotes for a proposed trade, each comprising a quoted price and a quoted size;
means for identifying within said plurality of quotes a best insufficient quote, wherein the quoted size of said best insufficient quote is less than a customer order size and greater than any other quoted size in said plurality of quotes;
a user interface comprising a display device and input means for receiving said customer order size;
means for storing said customer order size;
means for displaying on said display device a trading panel for the proposed trade comprising a plurality of price selectors, each representing one quoted price in said plurality of quotes, and a plurality of size selectors, each representing one quoted size in said plurality of quotes, wherein the size selector representing the quoted size for said best insufficient quote is visibly distinguished from size selectors representing quoted sizes for quotes other than said best insufficient quotes; and
means, responsive to activation of said input means to select any size selector in said trading panel, for booking an order using the quoted size represented by said any size selector.

74. A computer system for executing trades, comprising:
a network interface configured to receive a plurality of quotes for a proposed trade, each comprising a quoted price and a quoted size;
a quote processor configured to identify in said plurality of quotes a best insufficient quote and at least one other best insufficient quote, wherein said best insufficient quote and said at least one other best insufficient quote are received from different providers;
a user interface comprising a display device, an input device and a display screen generator, said display screen generator being configured to display on said display device
an input field configured to receive said customer order size from a customer, and
a trading panel comprising a plurality of price selectors, each representing one quoted price in said plurality of quotes, a plurality of size selectors, each representing one quoted size in said plurality of quotes, and a best multi-bank order selector, wherein the size selector representing the quoted size for said best insufficient quote is visibly distinguished from size selectors representing quoted sizes for quotes other than said best insufficient quote; and
an order processor, coupled to said user interface, configured to book an order for said proposed trade responsive to activation of said input device by said customer;
wherein
activation of said input device to select any size selector causes said order processor to book said order using the quoted size represented by said any size selector, and
activation of said input device to select said best multi-bank order selector causes said order processor to book at least two orders, said at least two orders comprising a first order based on said best insufficient quote and at least one other order based on said at least one other best insufficient quote.

75. The computer system of claim 74, wherein the quoted sizes of said best insufficient quote and said at least one other best insufficient quote are less than said customer order size and greater than any other quoted sizes in said plurality of quotes.

76. The computer system of claim 74, wherein
said trading panel further comprises a bid limit input control configured to receive a bid limit from said customer; and
said quote processor is further configured to exclude any best insufficient quote having a bid quoted price that is numerically lower than said bid limit.

77. The computer system of claim 74, wherein
said trading panel further comprises an ask limit input control configured to receive an ask limit from said customer; and
said quote processor is further configured to exclude any best insufficient quote having an ask quoted price that is numerically higher than said ask limit.

78. The computer system of claim 74, wherein said best multi-bank order selector comprises an indicator showing a numerically lowest bid quoted price to be used for booking said at least two orders.

79. The computer system of claim 74, wherein said best multi-bank order selector comprises an indicator showing a numerically highest ask quoted price to be used for booking said at least two orders.

80. The computer system of claim 74, wherein said best multi-bank order selector comprises an indicator showing the sum of all quoted sizes to be used for booking said at least two orders.

81. The computer system of claim 74, wherein said best multi-bank order selector comprises an indicator showing the average price of all quoted prices to be used for booking said at least two orders.

82. A computer-implemented method for executing trades, comprising:
receiving, via a network interface, a plurality of quotes for a proposed trade, each comprising a quoted price and a quoted size;
receiving, via an input field, a customer order size from a customer;
identifying in said plurality of quotes a best insufficient quote and at least one other best insufficient quote, wherein said best insufficient quote and said at least one other best insufficient quote are received from different providers;
displaying on a display device a trading panel comprising a plurality of price selectors, each representing one quoted price in said plurality of quotes, a plurality of size selectors, each representing one quoted size in said plurality of quotes, and a best multi-bank order selector, wherein the size selector representing the quoted size for said best insufficient quote is visibly distinguished from size selectors representing quoted sizes for quotes other than said best insufficient quote;
booking an order using the quoted size represented by any size selector, responsive to activation of an input device to select said any size selector; and
booking at least two orders responsive to activation of said input device to select said best multi-bank order selector, said at least two orders comprising a first order based on said best insufficient quote and at least one other order based on said at least one other best insufficient quote.

83. The computer-implemented method of claim 82, wherein the quoted sizes of said best insufficient quote and said at least one other best insufficient quote are less than said customer order size and greater than any other quoted sizes in said plurality of quotes.

84. The computer-implemented method of claim 82, further comprising:
receiving a bid limit from said customer; and
excluding any best insufficient quote having a bid quoted price that is numerically lower than said bid limit.

85. The computer-implemented method of claim 82, further comprising:
receiving an ask limit from said customer; and
excluding any best insufficient quote having an ask quoted price that is numerically higher than said ask limit.

86. A method for executing trades on a computer system having two modes of operation, said method comprising:
receiving, via a network interface, a plurality of quotes for a proposed trade, each comprising a quoted price and a quoted size;
receiving, via an input field, a customer order size from a customer; and
in a first mode of operation,
identifying a best insufficient quote in said plurality of quotes, wherein the quoted size of said best insufficient quote is less than said customer order size and greater than any other quoted size in said plurality of quotes,
displaying on a display device a trading panel comprising a plurality of price selectors, each representing one quoted price in said plurality of quotes, and a plurality of size selectors, each representing one quoted size in said plurality of quotes, wherein the size selector representing the quoted size for said best insufficient quote is visibly distinguished from size selectors representing quoted sizes for quotes other than said best insufficient quotes, and
booking an order using the quoted size represented by any size selector, responsive to activation of an input device to select said any size selector; and
in a second mode of operation,
identifying in said plurality of quotes said best insufficient quote and at least one other best insufficient quote, wherein said best insufficient quote and said at least one other best insufficient quote are received from different providers,
displaying on said display device a trading panel comprising said plurality of price selectors, said plurality of size selectors, and a best multi-bank order selector, wherein the size selector representing the quoted size for said best insufficient quote is visibly distinguished from size selectors representing quoted sizes for quotes other than said best insufficient quote, and
booking at least two orders responsive to activation of said input device to select said best multi-bank order selector, said at least two orders comprising a first order based on said best insufficient quote and at least one other order based on said at least one other best insufficient quote.

87. The method of claim 86, further comprising receiving a mode selection from said customer.

88. A computer system for executing trades, comprising:
a network interface configured to receive a plurality of quotes for a proposed trade, each comprising a quoted price and a quoted size;
a quote processor configured to identify a set of dealable quotes in said plurality of quotes, wherein the quoted size in each quote in said set of dealable quotes is not less than a customer order size for the proposed trade;
an input device;
a display device;
a display screen generator configured to display on said display device
an input field configured to receive said customer order size from a customer, and
a plurality of price selectors, each representing one quoted price in said plurality of quotes, and a plurality of size selectors, each representing one quoted size in said plurality of quotes, wherein price selectors for quoted prices in said set of dealable quotes are visibly distinguished from price selectors for quoted prices not in said set of dealable quotes; and
an order processor configured to book an order for said proposed trade responsive to activation of said input device by said customer;
wherein activation of said input device to select any price selector displayed on said display device causes said order processor to book said order using said customer order size and an order price equal to the quoted price represented by said any price selector.

89. The computer system of claim 88, wherein activation of said input device to select said any price selector causes said order processor to generate an offer to deal prior to booking said order.

90. The computer system of claim 88, wherein activation of said input device to select any size selector displayed on said display device causes said order processor to book said order using the quoted size represented by said any size selector.

91. The computer system of claim 88, wherein activation of said input device to select said any size selector causes said order processor to generate an offer to deal prior to booking said order.

92. The computer system of claim 88, wherein said quote processor is further configured to determine a best dealable quote within said set of dealable quotes, said best dealable quote having an ask quoted price that is less than or equal to every other ask quoted price in said set of dealable quotes.

93. The computer system of claim 92, wherein the price selector representing said ask quoted price for said best dealable quote is visibly distinguished from price selectors representing ask quoted prices for dealable quotes other than said best dealable quote.

94. The computer system of claim 88, wherein said quote processor is further configured to determine a best dealable quote within said set of dealable quotes, said best dealable quote having a bid quoted price that is greater than or equal to every other bid quoted price in said set of dealable quotes.

95. The computer system of claim 94, wherein the price selector representing said bid quoted price for said best dealable quote is visibly distinguished from price selectors representing bid quoted prices for dealable quotes other than said best dealable quote.

96. The computer system of claim 88, wherein said plurality of quotes are associated with a plurality of proposed trades.

97. The computer system of claim 96, wherein:
said quote processor is further configured to identify a group of best dealable quotes comprising at least one best dealable quote for each proposed trade in the plurality of proposed trades; and
said display screen generator is further configured to display on said display device a plurality of best dealable quote selectors, each representing an individual best dealable quote in said group of best dealable quotes.

98. The computer system of claim 97, wherein activation of said input device by said customer to select any best dealable quote selector from the plurality of best dealable quote selectors causes said order processor to book said order using said customer order size and the individual best dealable quote represented by said any best dealable quote selector.

99. A computer-implemented method for executing trades, comprising:
receiving, via a network interface, a plurality of quotes for a proposed trade, each comprising a quoted price and a quoted size;
receiving, via an input field, a customer order size from a customer;
identifying in said plurality of quotes a first quote and at least one other quote, wherein said first quote and said at least one other quote are received from different providers;
displaying on a display device a trading panel comprising a plurality of price selectors, each representing one quoted price in said plurality of quotes, a plurality of size selectors, each representing one quoted size in said plurality of quotes, and a best multi-bank order selector, wherein the size selector representing the quoted size for said first quote is visibly distinguished from size selectors representing quoted sizes for quotes other than said first quote;
booking an order using the quoted size represented by any size selector, responsive to activation of an input device to select said any size selector; and
booking at least two orders responsive to activation of said input device to select said best multi-bank order selector, said at least two orders comprising a first order based on said first quote and at least one other order based on said at least one other quote.
